(19) United States
(12) Patent Application Publication
(10) Pub. No.: US 2016/0088602 A1
(43) Pub. Date: Mar. 24, 2016

(54) UPLINK ACKNOWLEDGMENT RESPONSE TO DOWNLINK MULTIPLE USER TRANSMISSION

(71) Applicant: NEWRACOM, INC., Irvine, CA (US)

(72) Inventor: Yongho SEOK, Irvine, CA (US)

(21) Appl. No.: 14/800,366

(22) Filed: Jul. 15, 2015

Related U.S. Application Data
(60) Provisional application No. 62/024,963, filed on Jul. 15, 2014.

(30) Foreign Application Priority Data
Jul. 21, 2014 (KR) 10-2014-0091873

(51) Int. Cl. H04W 72/04; H04L 5/00

(52) U.S. Cl. CPC H04W 72/0406; H04L 5/0055; H04W 72/0446; H04W 84/12

(57) ABSTRACT

The present invention provides a method and apparatus for transmitting an Uplink (UL) ACKnowledgement (ACK) in response to a Downlink (DL) Multi-User (MU) transmission in a Wireless Local Area Network (WLAN). According to one aspect of the present invention, a method for transmitting an ACK in response to a DL data transmission from an Access Point (AP) by a Station (STA) in a WLAN may be provided. The method may include receiving, from the AP, a downlink frame including downlink data for the STA and downlink data for one or other STAs, and transmitting an ACK frame to the AP in response to the downlink data for the S_TA, simultaneously with transmission of ACK frames from the one or more other STAs. The ACK frames transmitted by the STA and the one or more other STAs may have the same length.

This application claims the benefit of U.S. Provisional Application No. 62/024,963, filed on Jul. 15, 2014, which is hereby incorporated by reference as if fully set forth herein. This application claims the benefit of Korean Patent Application No. 10-2014-0091873, filed on Jul. 21, 2014, which is hereby incorporated by reference as if fully set forth herein.

### BACKGROUND OF THE INVENTION

1. Field of the Invention

The present invention relates to a Wireless Local Area Network (WLAN), and more particularly, to an uplink acknowledgment procedure in response to a downlink multi-user transmission in a High Efficiency WLAN (HEW), a transmission method, reception method, transmission apparatus, reception apparatus, and software using the uplink acknowledgment procedure, and a recording medium that stores the software.

2. Discussion of the Related Art

Along with the recent development of information and telecommunication technology, various wireless communication techniques have been developed. Among them, the WLAN enables a user to wirelessly access the Internet based on radio frequency technology in a home, an office, or a specific service area using a portable terminal such as a Personal Digital Assistant (PDA), a laptop computer, a Portable Multimedia Player (PMP), a smartphone, etc.

To overcome limitations in communication speed that the WLAN faces, the recent technical standards have introduced a system that increases the speed, reliability, and coverage of a wireless network. For example, the Institute of Electrical and Electronics Engineers (IEEE) 802.11n standard has introduced Multiple Input Multiple Output (MIMO) that is implemented using multiple antennas at both a transmitter and a receiver in order to support High Throughput (HT) at a data processing rate of up to 540 Mbps, minimize transmission errors, and optimize data rates.

### SUMMARY OF THE INVENTION

Objects of the present invention is to provide a new method for performing an acknowledgement procedure in response to a multi-user transmission (i.e., a Multi-User Multiple Input Multiple Output (MU-MIMO) or Orthogonal Frequency Division Multiple Access (OFDMA) transmission) and a new method for determining frequency resources in which a multi-user transmission is performed, in order increase the use efficiency of radio resources.

The objects of the present invention are not limited to the foregoing descriptions, and additional objects will become apparent to those having ordinary skill in the pertinent art to the present invention based upon the following descriptions.

In an aspect of the present invention, a method for transmitting an ACK in response to a DL data transmission from an Access Point (AP) by a Station (STA) in a WLAN may be provided. The method may include receiving, from the AP, a downlink frame including downlink data for the STA and downlink data for one or other STAs, and transmitting an ACK frame to the AP in response to the downlink data for the STA, simultaneously with transmission of ACK frames from the one or more other STAs. The ACK frames transmitted by the STA and the one or more other STAs may have the same length.

In another aspect of the present invention, a method for receiving an ACK in response to a downlink data transmission to a plurality of STAs by an AP in a WLAN may be provided. The method may include receiving frames triggering the downlink data transmission from one or more of the plurality of STAs, transmitting a downlink frame including downlink data for the plurality of STAs to the plurality of STAs, and receiving ACK frames from one or more other STAs, simultaneously with an ACK frame from one of the plurality of STAs. The ACK frames transmitted by the plurality of STAs may have the same length.

In another aspect of the present invention, an apparatus of an STA for transmitting an ACK in response to a DL data transmission from an AP in a WLAN may be provided. The apparatus may include a baseband processor, a Radio Frequency (RF) transceiver, and a memory. The baseband processor may be configured to receive, from the AP, a downlink frame including downlink data for the STA and downlink data for one or other STAs, using the transceiver, and transmit an ACK frame to the AP in response to the downlink data for the STA, using the transceiver, simultaneously with transmission of ACK frames from the one or more other STAs. The ACK frames transmitted by the STA and the one or more other STAs may have the same length.

In another aspect of the present invention, an apparatus of an AP for receiving an ACK in response to a downlink data transmission to a plurality of STAs in a WLAN may be provided. The apparatus may include a baseband processor, a transceiver, and a memory. The baseband processor may be configured to receive frames triggering the downlink data transmission from one or more of the plurality of STAs using the transceiver, transmit a downlink frame including downlink data for the plurality of STAs to the plurality of STAs using the transceiver, and receive ACK frames from one or more other STAs using the transceiver, simultaneously with an ACK frame from one of the plurality of STAs. The ACK frames transmitted by the plurality of STAs may have the same length.

In another aspect of the present invention, a software or a computer-readable medium having executable instructions for transmitting an ACK in response to a DL data transmission from an AP by an STA in a WLAN may be provided. The executable instructions may cause the STA to receive, from the AP, a downlink frame including downlink data for the STA and downlink data for one or other STAs, and transmit an ACK frame to the AP in response to the downlink data for the STA, simultaneously with transmission of ACK frames from the one or more other STAs. The ACK frames transmitted by the STA and the one or more other STAs may have the same length.

In another aspect of the present invention, a software or a computer-readable medium having executable instructions for receiving an ACK in response to a downlink data transmission to a plurality of STAs by an AP in a WLAN may be provided. The executable instructions may cause the AP to receive frames triggering the downlink data transmission from one or more of the plurality of STAs, transmit a downlink frame including downlink data for the plurality of STAs to the plurality of STAs, and receive ACK frames from one or more other STAs, simultaneously with an ACK frame from one of the plurality of STAs. The ACK frames transmitted by the plurality of STAs may have the same length.

It is to be understood that both the foregoing summarized features are exemplary aspects of the following detailed description of the present invention without limiting the scope of the present invention.

According to the present invention, a technique for increasing the use efficiency of radio resources can be supported by providing a new method for performing an acknowledgement procedure in response to a multi-user transmission (i.e., an MU-MIMO or OFDMA transmission) and a new method for determining frequency resources in which a multi-user transmission is performed.

The advantages of the present invention are not limited to the foregoing descriptions, and additional advantages will become apparent to those having ordinary skill in the pertinent art to the present invention based upon the following descriptions.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a Wireless Local Area Network (WLAN) device;

FIG. 2 is a schematic block diagram of an exemplary transmission signal processing unit in a WLAN;

FIG. 3 is a schematic block diagram of an exemplary reception signal processing unit in a WLAN;

FIG. 4 depicts a relationship between InterFrame Spaces (IFSs);

FIG. 5 is a conceptual diagram illustrating a procedure for transmitting a frame in Carrier Sense Multiple Access with Collision Avoidance (CSMA/CA) to avoid collision between frames on a channel;

FIG. 6 depicts an exemplary frame structure in a WLAN system;

FIG. 7 depicts an exemplary High Efficiency (HE) Physical layer Protocol Data Unit (PPDU) frame format according to the present invention;

FIG. 8 depicts subchannel allocation in a HE PPDU frame format according to the present invention;

FIG. 9 depicts a subchannel allocation method according to the present invention;

FIG. 10 depicts the starting and ending points of an High Efficiency Long Training Field (HE-LTF) field in a HE PPDU frame format according to the present invention;

FIG. 11 depicts a High Efficiency SIGnal B (HE-SIG-B) field and a High Efficiency SIGnal C (HE-SIG-C) field in the HE PPDU frame format according to the present invention;

FIG. 12 depicts another exemplary HE PPDU frame format according to the present invention; exemplary

FIG. 13 depicts an exemplary block ACKnowledgement (ACK) procedure in response to an Uplink (UL) Multi-User (MU) transmission according to the present invention;

FIG. 14 depicts another exemplary block ACK procedure in response to a UL MU transmission according to the present invention;

FIG. 15 depicts an error recovery procedure for a UL MU transmission according to the present invention;

FIG. 16 depicts an exemplary ACK procedure performed in response to a DL MU transmission according to the present invention;

FIG. 17 depicts another exemplary ACK procedure performed in response to a DL MU transmission according to the present invention;

FIG. 18 depicts another exemplary ACK procedure performed in response to a DL MU transmission according to the present invention;

FIG. 19 depicts an error recovery procedure for a DL MU transmission according to the present invention;

FIG. 20 depicts an example of determining subchannels for an MU transmission according to the present invention;

FIGS. 21 and 22 depict other examples of determining subchannels for an MU transmission according to the present invention; and

FIG. 23 is a flowchart illustrating an exemplary method according to the present invention.

### DETAILED DESCRIPTION OF THE INVENTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In a Wireless Local Area network (WLAN), a Basic Service Set (BSS) includes a plurality of WLAN devices. A WLAN device may include a Medium Access Control (MAC) layer and a PHYsical (PHY) layer in conformance to Institute of Electrical and Electronics Engineers (IEEE) 802.11 series standards. At least one of the WLAN devices may be an Access Point (AP) and the other WLAN devices may be non-AP Stations (non-AP STAs). Alternatively, all of the WLAN devices may be non-AP STAs in an ad-hoc network. Generally, the term STA covers AP STA and non-AP STA. However, only a non-AP STA may be referred to as a STA, for the convenience's sake.

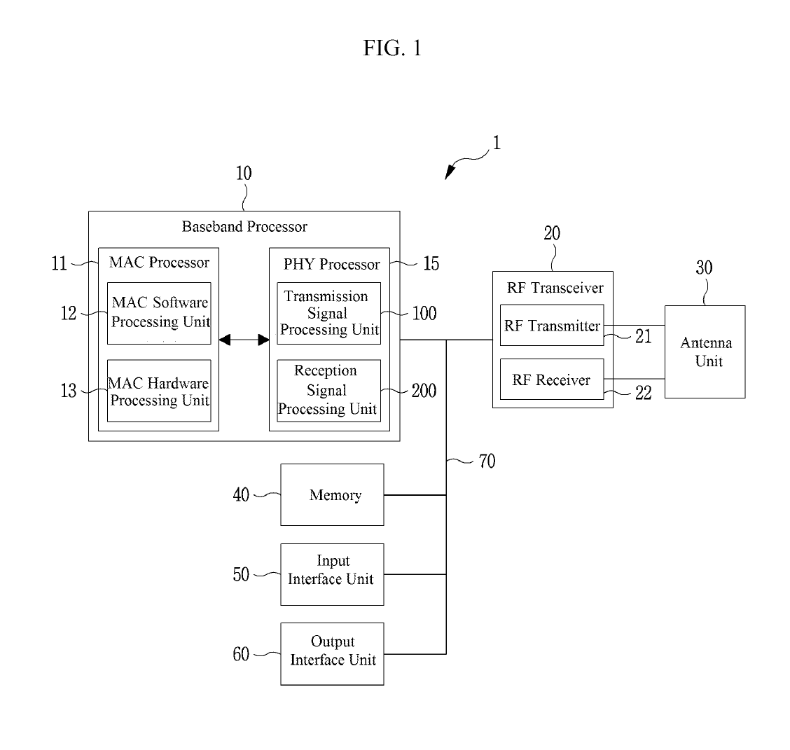

FIG. 1 is a block diagram of a WLAN device.

Referring to FIG. 1, a WLAN device 1 includes a baseband processor 10, a Radio Frequency (RF) transceiver 20, an antenna unit 30, a memory 40, an input interface unit 50, an output interface unit 60, and a bus 70.

The baseband processor 10 may be simply referred to as a processor, performs baseband signal processing described in the present specification, and includes a MAC processor (or MAC entity) 11 and a PHY processor (or PHY entity) 15.

In an embodiment of the present invention, the MAC processor 11 may include a MAC software processing unit 12 and a MAC hardware processing unit 13. The memory 40 may store software (hereinafter referred to as ‘MAC software’) including at least some functions of the MAC layer. The MAC software processing unit 12 may execute the MAC software to implement some functions of the MAC layer, and the MAC hardware processing unit 13 may implement the remaining functions of the MAC layer as hardware (hereinafter referred to as ‘MAC hardware’). However, the MAC processor 11 is not limited to the foregoing implementation examples.

The PHY processor 15 includes a transmission signal processing unit 100 and a reception signal processing unit 200.

The baseband processor 10, the memory 40, the input interface unit 50, and the output interface unit 60 may communicate with one another via the bus 70.

The RF transceiver 20 includes an RF transmitter 21 and an RF receiver 22.

The memory 40 may further store an Operating System (OS) and applications. The input interface unit 50 receives information from a user, and the output interface unit 60 outputs information to the user.

The antenna unit 30 includes one or more antennas. When Multiple input Multiple Output (MIMO) or Multi-User MIMO (MU-MIMO) is used, the antenna unit 30 may include a plurality of antennas.

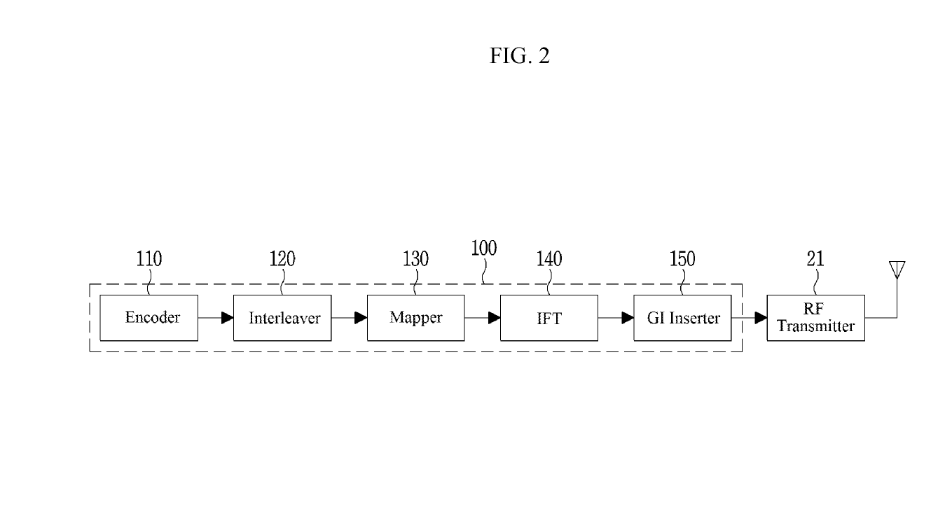

FIG. 2 is a schematic block diagram of an exemplary transmission signal processor in a WLAN.

Referring to FIG. 2, the transmission signal processing unit 100 includes an encoder 110, an interleave 120, a mapper 130, an Inverse Fourier Transform (IFT) processor 140, and a Guard Interval (GI) inserter 150.

The encoder 110 encodes input data. For example, the encoder 100 may be a Forward Error Correction (FEC) encoder. The FEC encoder may include a Binary Convolutional Code (BCC) encoder followed by a puncturing device, or the FEC encoder may include a Low-Density Parity-Check (LDPC) encoder.

The transmission signal processing unit 100 may further include a scrambler for scrambling input data before encoding to reduce the probability of long sequences of 0s or 1s. If a BCC encoding scheme is used in the encoder 110, the transmission signal processing unit 100 may further include an encoder parser for demultiplexing the scrambled bits among a plurality of BCC encoders. If an LDPC encoding scheme is used in the encoder 110, the transmission signal processing unit 100 may not use the encoder parser.

The interleaver 120 interleaves the bits of each stream output from the encoder 110 to change orders of bits. Interleaving may be applied only when a BCC encoding scheme is used in the encoder 110. The mapper 130 maps a sequence of bits output from the interleaver 120 to constellation points. If an LDPC encoding scheme is used in the encoder 110, the mapper 130 may further perform LDPC tone mapping besides the constellation point mapping.

In MIMO or MU-MIMO, the transmission signal processing unit 100 may use as many interleavers 120 as and as many mappers 130 as the number N_{SS} of spatial streams. In this case, the transmission signal processing unit 100 may further include a stream parser for dividing the outputs of the BCC encoders or the output of the LDPC encoder into a plurality of blocks to be provided to the different interleavers 120 or mappers 130. The transmission signal processing unit 100 may further include a Space-Time Block Code (STBC) encoder for spreading the constellation points from N_{SS} spatial streams into N_{STS} space-time streams and a spatial mapper for mapping the space-time streams to transmit chains. The spatial mapper may use direct mapping, spatial expansion, or beamforming.

The IFT processor 140 converts a block of constellation points output from the mapper 130 or the spatial mapper to a time-domain block (i.e., a symbol) by Inverse Discrete Fourier Transform (IDFT) or Inverse Fast Fourier Transform (IFFT). If the STBC encoder and the spatial mapper are used, the IFT processor 140 may be provided for each transmit chain.

In MIMO or MU-MIMO, the transmission signal processing unit 100 may insert Cyclic Shift Diversities (CSDs) in order to prevent unintended beamforming A CSD insertion may applied before or after IFT. A CSD may be specified for each transmit chain or for each space-time stream. Alternatively, the CSD may be applied as a part of the spatial mapper.

In MU-MIMO, some blocks before the spatial mapper may be provided for each user.

The GI inserter 150 prepends a GI to a symbol. The transmission signal processing unit 100 may optionally perform windowing to smooth edges of each symbol after inserting the GI. The RF transmitter 21 converts the symbols into an RF signal and transmits the RF signal via the antenna unit 30. In MIMO or MU-MIMO, the GI inserter 150 and the RF transmitter 21 may be provided for each transmit chain.

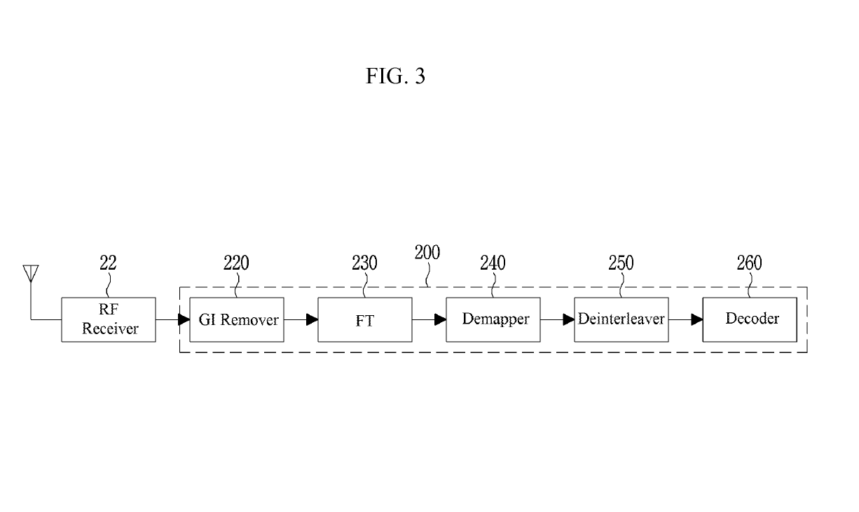

FIG. 3 is a schematic block diagram of an exemplary a reception signal processor in a WLAN.

Referring to FIG. 3, the reception signal processing unit 200 includes a GI remover 220, a Fourier Transform (FT) processor 230, a demapper 240, a deinterleaver 250, and a decoder 260.

The RF receiver 22 receives an RF signal via the antenna unit 30 and converts the RF signal into symbols. The GI remover 220 removes a GI from the symbols. In MIMO or MU-MIMO, the RF receiver 22 and the GI remover 220 may be provided for each receive chain.

The FT 230 converts the symbol (i.e., the time-domain block) into a block of constellation points by Discrete Fourier Transform (DFT) or Fast Fourier Transform (FFT). The FT processor 230 may be provided for each receive chain.

In MIMO or MU-MIMO, the reception signal processing unit 200 may include a spatial demapper for converting Fourier Transformed receiver chains to constellation points of space-time streams, and an STBC decoder for despreading the constellation points from the space-time streams into the spatial streams.

The demapper 240 demaps constellation points output from the FT processor 230 or the STBC decoder to bit streams. If an LDPC encoding scheme has been applied to the received signal, the demapper 240 may further perform LDPC tone demapping before the constellation demapping. The deinterleaver 250 deinterleaves the bits of each of the streams output from the demapper 240. Deinterleaving may be applied only when a BCC encoding scheme has been applied to the received signal.

In MIMO or MU-MIMO, the reception signal processing unit 200 may use as many demappers 240 as and as many deinterleavers 250 as the number of spatial streams. In this case, the reception signal processing unit 200 may further include a stream deparser for combining streams output from the deinterleavers 250.

The decoder 260 decodes streams output from the deinterleaver 250 or the stream deparser. For example, the decoder 100 may be an FEC decoder. The FEC decoder may include a BCC decoder or an LDPC decoder. The reception signal processing unit 200 may further include a descrambler for descrambling the decoded data. If a BCC decoding scheme is used in the decoder 260, the reception signal processing unit 200 may further include an encoder deparser for multiplexing data decoded by a plurality of BCC decoders. If an LDPC decoding scheme is used in the decoder 260, the reception signal processing unit 200 may not use the encoder deparser.

In a WLAN system, Carrier Sense Multiple Access with Collision Avoidance (CSMA/CA) is a basic MAC access mechanism. The CSMA/CA mechanism is referred to as Distributed Coordination Function (DCF) of IEEE 802.11 MAC, shortly as a ‘listen before talk’ access mechanism. According to the CSMA/CA mechanism, an AP and/or a STA may sense a medium or a channel for a predetermined time before starting transmission, that is, may perform Clear Channel Assessment (CCA). If the AP or the STA determines that the medium or channel is idle, it may start to transmit a frame on the medium or channel. On the other hand, if the AP and/or the STA determines that the medium or channel is occupied or busy, it may set a delay period (e.g., a random backoff period), wait for the delay period without starting transmission, and then attempt to transmit a frame. By applying a random backoff period, a plurality of STAs are expected to attempt frame transmission after waiting for different time periods, resulting in minimizing collisions.

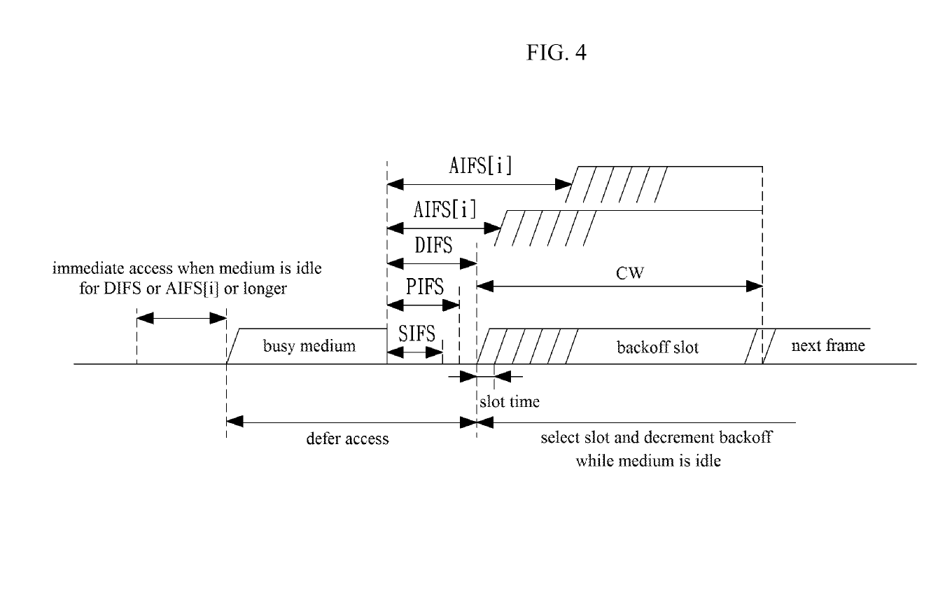

FIG. 4 depicts a relationship between InterFrame Spaces (IFSs).

WLAN devices may exchange data frames, control frames, and management frames with each other.

A data frame is used for transmission of data to be forwarded to a higher layer. After a Distributed Coordination Function IFS (DIFS) from a time when a medium gets idle, a WLAN device performs a backoff and then transmits a data frame. A management frame is used for exchanging management information which is not forwarded to the higher layer. After an IFS such as the DIFS or a Point Coordination Function IFS (PIFS), the WLAN device transmits the management frame. Subtype frames of the management frame include a beacon frame, an association request/response frame, a probe request/response frame, and an authentication request/response frame. A control frame is used for controlling access to the medium. Subtype frames of the control frame include a Request-To-Send (RTS) frame, a Clear-To-Send (CTS) frame, and an ACKnowledgement (ACK) frame. If the control frame is not a response frame to another frame, the WLAN device performs a backoff after the DIFS and then transmits the control frame; or if the control frame is a response frame to another frame, the WLAN device transmits the control frame after a Short IFS (SIFS) without a backoff. The type and subtype of a frame may be identified by a type field and a subtype field in a Frame Control (FC) field.

On the other hand, a Quality of Service (QoS) STA may perform a backoff after an Arbitration IFS (AIFS) for Access Category (AC), i.e., AIFS[i] (i is determined based on AC) and then transmit a frame. In this case, the AIFC[i] may be used for a data frame, a management frame, or a control frame that is not a response frame.

In the example illustrated in FIG. 4, upon generation of a frame to be transmitted, a STA may transmit the frame immediately, if it determines that the medium is idle for the DIFS or AIFS[i] or longer. The medium is busy for a time period during which the STA transmits the frame. During the time period, upon generation of a frame to be transmitted, another STA may defer access by confirming that the medium is busy. If the medium gets idle, the STA that intends to transmit the frame may perform a backoff operation after a predetermined IFS in order to minimize collision with any other STA. Specifically, the STA that intends to transmit the frame selects a random backoff count, waits for a slot time corresponding to the selected random backoff count, and then attempt transmission. The random backoff count is determined based on a Contention Window (CW) parameter and the medium is monitored continuously during count-down of backoff slots (i.e. decrement a backoff count-down) according to the determined backoff count. If the STA monitors the medium as busy, the STA discontinues the count-down and waits, and then, if the medium gets idle, the STA resumes the count-down. If the backoff slot count reaches 0, the STA may transmit the next frame.

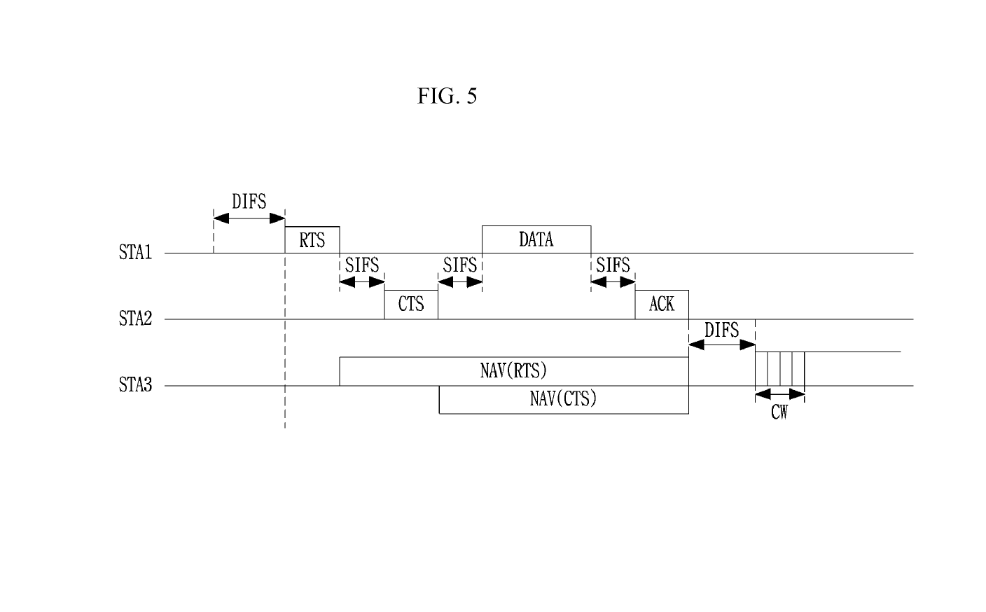

FIG. 5 is a conceptual diagram illustrating a CSMA/CA-based frame transmission procedure to avoid collision between frames on a channel.

Referring FIG. 5, a first STA (STA1) is a transmitting WLAN device having data to be transmitted, a second STA (STA2) is a receiving WLAN device to receive the data from STA1, and a third STA (STA3) is a WLAN device located in an area where STA3 may receive a frame from STA1 and/or STA2.

STA1 may determine whether a channel is busy by carrier sensing. STA1 may determine channel occupancy based on an energy level of the channel or a correlation between signals on the channel, or using a Network Allocation Vector (NAV) timer.

If STA1 determines that the channel is not used by other devices during a DIFS (that is, the channel is idle), STA1 may transmit an RTS frame to STA2 after performing a backoff. Upon receipt of the RTS frame, STA2 may transmit a CTS frame as a response to the CTS frame after a SIFS.

Upon receipt of the RTS frame, STA3 may set a NAV timer for a transmission duration of following frames (e.g., a SIFS time+a CTS frame duration+a SIFS time+a data frame duration+a SIFS time+an ACK frame duration), based on duration information included in the RTS frame. Upon receipt of the CTS frame, STA3 may set the NAV timer for a transmission duration of following frames (e.g., a SIFS time+a data frame duration+a SIFS time+an ACK frame duration), based on duration information included in the CTS frame. Upon receipt of a new frame before the NAV timer expires, STA3 may update the NAV timer based on duration information included in the new frame. STA3 does not attempt to access the channel until the NAV timer expires.

Upon receipt of the CTS frame from STA2, STA1 may transmit a data frame to STA2 a SIFS after the CTS frame has been completely received. Upon successful receipt of the data frame from STA1, STA2 may transmit an ACK frame as a response to the data frame after a SIFS.

Upon expiration of the NAV timer, STA3 may determine whether the channel is busy by carrier sensing. If STA3 determines that the channel is not in use by the other devices during a DIFS after expiration of the NAV timer, STA3 may attempt channel access after a convention window according a random backoff-based CW.

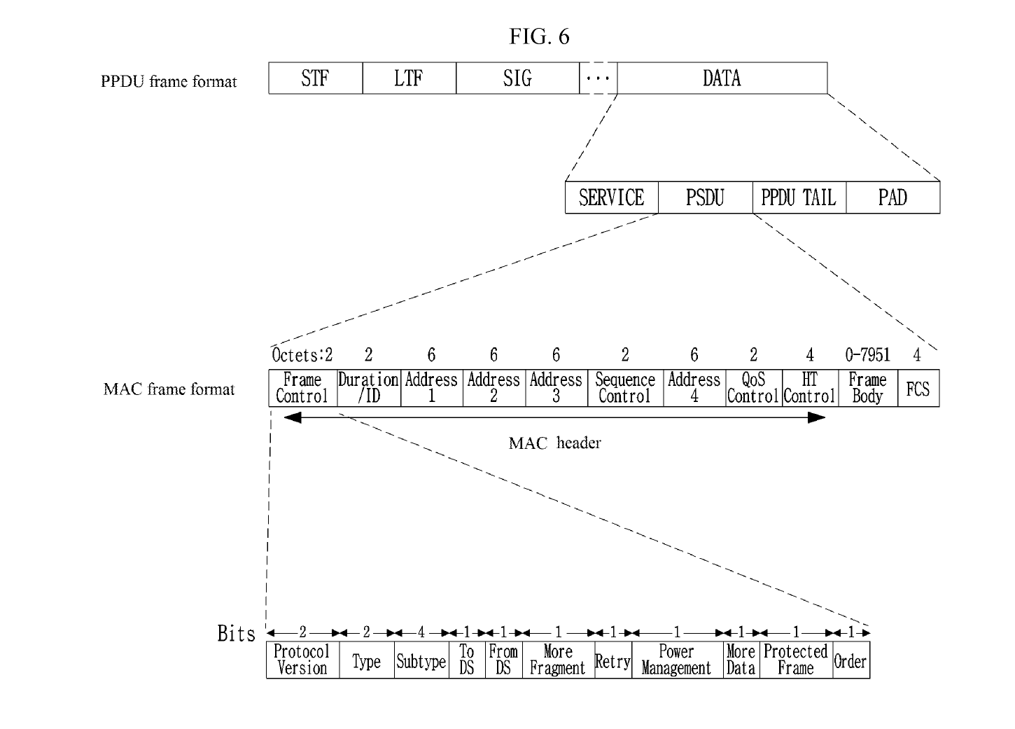

FIG. 6 depicts an exemplary frame structure in a WLAN system.

PHY layer may prepare a transmission MAC PDU (MPDU) in response to an instruction (or a primitive, which is a set of instructions or a set of parameters) by the MAC layer. For example, upon receipt of an instruction requesting transmission start from the MAC layer, the PHY layer may switch to a transmission mode, construct a frame with information (e.g., data) received from the MAC layer, and transmit the frame.

Upon detection of a valid preamble in a received frame, the PHY layer monitors a header of the preamble and transmits an instruction indicating reception start of the PHY layer to the MAC layer.

Information is transmitted and received in frames in the WLAN system. For this purpose, a Physical layer Protocol Data Unit (PPDU) frame format is defined.

A PPDU frame may include a Short Training Field (STF) field, a Long Training Field (LTF) field, a SIGNAL (SIG) field, and a Data field. The most basic (e.g., a non-High Throughput (non-HT)) PPDU frame may include only a Legacy-STF (L-STF) field, a Legacy-LTF (L-LTF) field, a SIG field, and a Data field. Additional (or other types of) STF, LTF, and SIG fields may be included between the SIG field and the Data field according to the type of a PPDU frame format (e.g., an HT-mixed format PPDU, an HT-greenfield format PPDU, a Very High Throughput (VHT) PPDU, etc.).

The STF is used for signal detection, Automatic Gain Control (AGC), diversity selection, fine time synchronization, etc. The LTF field is used for channel estimation, frequency error estimation, etc. The STF and the LTF fields may be referred to as signals for OFDM PHY layer synchronization and channel estimation.

The SIG field may include a RATE field and a LENGTH field. The RATE field may include information about a modulation scheme and coding rate of data. The LENGTH field may include information about the length of the data. The SIG field may further include parity bits, SIG TAIL bits, etc.

The Data field may include a SERVICE field, a Physical layer Service Data Unit (PSDU), and PPDU TAIL bits. When needed, the Data field may further include padding bits. A part of the bits of the SERVICE field may be used for synchronization at a descrambler of a receiver. The PSDU corresponds to a MAC PDU defined at the MAC layer and may include data generated/used in a higher layer. The PPDU TAIL bits may be used to return an encoder to a zero state. The padding bits may be used to match the length of the Data filed in predetermined units.

A MAC PDU is defined according to various MAC frame formats. A basic MAC frame includes a MAC header, a frame body, and a Frame Check Sequence (FCS). The MAC frame includes a MAC PDU and may be transmitted and received in the PSDU of the data part in the PPDU frame format.

The MAC header includes a Frame Control field, a Duration/Identifier (ID) field, an Address field, etc. The Frame Control field may include control information required for frame transmission/reception. The Duration/ID field may be set to a time for transmitting the frame. For details of Sequence Control, QoS Control, and HT Control subfields of the MAC header, refer to the IEEE 802.11-2012 technical specification.

The Frame Control field of the MAC header may include Protocol Version, Type, Subtype, To DS, From DS, More Fragment, Retry, Power Management, More Data, Protected Frame, and Order subfields. For the contents of each subfield in the Frame Control field, refer to the IEEE 802.11-2012 technical specification.

A Null-Data Packet (NDP) frame format is a frame format that does not include a data packet. In other words, the NDP frame format includes only a Physical Layer Convergence Protocol (PLCP) header part (i.e., the STF, LTF, and SIG fields) of the general PPDU frame format, without the remaining part (i.e., the Data field) of the general PPDU frame format. The NDP frame format may be referred to as a short frame format.

The IEEE 802.11ax task group is discussing a WLAN system, called a High Efficiency WLAN (HEW) system, that operates in 2.4 GHz or 5 GHz and supports a channel bandwidth (or channel width) of 20 MHz, 40 MHz, 80 MHz, or 160 MHz. The present invention defines a new PPDU frame format for the IEEE 802.11ax HEW system. The new PPDU frame format may support MU-MIMO or OFDMA. A PPDU of the new format may be referred to as a ‘HEW PPDU’ or ‘HE PPDU’ (similarly, HEW xyz may be referred to as ‘HE xyz’ or ‘HE-xyz’ in the following descriptions).

In present specification, the term ‘MU-MIMO or OFDMA mode’ includes MU-MIMO without using OFDMA, or OFDMA mode without using MU-MIMO in an orthogonal frequency resource, or OFDMA mode using MU-MIMO in an orthogonal frequency resource.

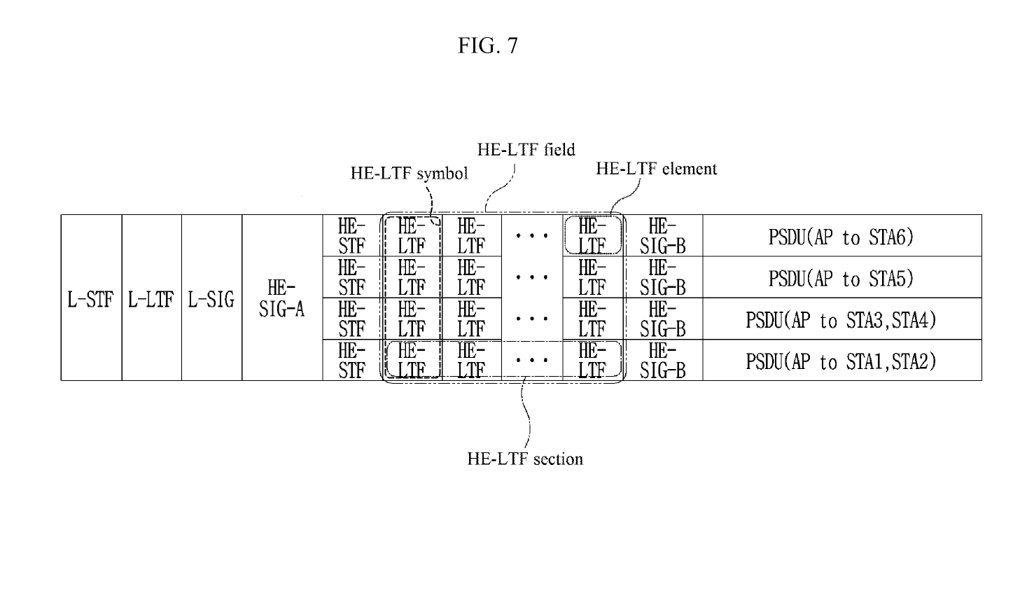

FIG. 7 depicts an exemplary HE PPDU frame format according to the present invention.

Referring to FIG. 7, the vertical axis represents frequency and the horizontal axis represents time. It is assumed that frequency and time increase in the upward direction and the right direction, respectively.

In the example of FIG. 7, one channel includes four subchannels. An L-STF, an L-LTF, an L-SIG, and an HE-SIG-A may be transmitted per channel (e.g., 20 MHz), a HE-STF and a HE-LTF may be transmitted on each subchannel being a basic subchannel unit (e.g., 5 MHz), and a HE-SIG-B and a PSDU may be transmitted on each of subchannels allocated to a STA. A subchannel allocated to a STA may have a size required for PSDU transmission to the STA. The size of the subchannel allocated to the STA may be N (N=1, 2, 3, . . . ) times as large as the size of basic subchannel unit (i.e., a subchannel having a minimum size). In the example of FIG. 7, the size of a subchannel allocated to each STA is equal to the size of the basic subchannel unit. For example, a first subchannel may be allocated for PSDU transmission from an AP to STA1 and STA2, a second subchannel may be allocated for PSDU transmission from the AP to STA3 and STA4, a third subchannel may be allocated for PSDU transmission from the AP to STA5, and a fourth subchannel may be allocated for PSDU transmission from the AP to STAG.

While the term subchannel is used in the present disclosure, the term subchannel may be referred to as Resource Unit (RU) or subband. A subchannel refers to a frequency band allocated to a STA and a basic subchannel unit refers to a basic unit used to represent the size of a subchannel. While the size of the basic subchannel unit is 5 MHz in the above example, this is purely exemplary. Thus, the basic subchannel unit may have a size of 2.5 MHz.

In FIG. 7, a plurality of HE-LTF elements are distinguished in the time and frequency domains. One HE-LTF element may correspond to one OFDM symbol in time domain and one subchannel unit (i.e., a subchannel bandwidth allocated to a STA) in frequency domain. The HE-LTF elements should be understood as logical units and the PHY layer does not necessarily operate in units of an HE-LTF element. In the following description, a HE-LTF element may be referred to shortly as a HE-LTF.

A HE-LTF symbol may correspond to a set of HE-LTF elements in one OFDM symbol in time domain and in one channel unit (e.g., 20 MHz) in frequency domain.

A HE-LTF section may correspond to a set of HE-LTF elements in one or more OFDM symbols in time domain and in one subchannel unit (i.e., a subchannel bandwidth allocated to a STA) in frequency domain.

A HE-LTF field may be a set of HE-LTF elements, HE-LTF symbols, or HE-LTF sections for a plurality of stations.

The L-STF field is used for frequency offset estimation and phase offset estimation, for preamble decoding at a legacy STA (i.e., a STA operating in a system such as IEEE 802.11a/b/g/n/ac). The L-LTF field is used for channel estimation, for the preamble decoding at the legacy STA. The L-SIG field is used for the preamble decoding at the legacy STA and provides a protection function for PPDU transmission of a third-party STA (e.g., setting a NAV based on the value of a LENGTH field included in the L-SIG field).

HE-SIG-A (or HEW SIG-A) represents High Efficiency Signal A (or High Efficiency WLAN Signal A), and includes HE PPDU (or HEW PPDU) modulation parameters, etc. for HE preamble (or HEW preamble) decoding at a HE STA (or HEW STA). The parameters set included in the HEW SIG-A field may include one or more of Very High Throughput (VHT) PPDU modulation parameters transmitted by IEEE 802.11ac stations, as listed in [Table 1] below, to ensure backward compatibility with legacy STAs (e.g., IEEE 802.11ac stations).

TABLE 1

| Two parts of | | | Number | |
|---|---|---|---|---|
| VHT-SIG-A | Bit | Field | of bits | Description |
| VHT-SIG-A1 | B0-B1 | BW | 2 | Set to 0 for 20 MHz, 1 for 40 MHz, 2 for 80 MHz, and 3 for |
| | | | | 160 MHz and 80 + 80 MHz |
| | B2 | Reserved | 1 | Reserved. Set to 1. |
| | B3 | STBC | 1 | For a VHT SU PPDU: |
| | | | | Set to 1 if space time block coding is used and set to 0 |
| | | | | otherwise. |
| | | | | For a VHT MU PPDU: |
| | | | | Set to 0. |
| | B4-B9 | Group ID | 6 | Set to the value of the TXVECTOR parameter GROUP_ID. |
| | | | | A value of 0 or 63 indicates a VHT SU PPDU; otherwise, |
| | | | | indicates a VHT MU PPDU. |
| | B10-B21 | NSTS/Partial | 12 | For a VHT MU PPDU: NSTS is divided into 4 user |
| | | AID | | positions of 3 bits each. User position p, where 0 ≦ p ≦ 3, |
| | | | | uses bits B(10 + 3p) to B(12 + 3p). The number of space- |
| | | | | time streams for user u are indicated at user position |
| | | | | p = USER_POSITION[u] where |
| | | | | u = 0, 1, . . . , NUM_USERS − 1 and the notation A[b] denotes |
| | | | | the value of array A at index b. Zero space-time streams are |
| | | | | indicated at positions not listed in the USER_POSITION |
| | | | | array. Each user position is set as follows: |
| | | | | Set to 0 for 0 space-time streams |
| | | | | Set to 1 for 1 space-time stream |
| | | | | Set to 2 for 2 space-time streams |
| | | | | Set to 3 for 3 space-time streams |
| | | | | Set to 4 for 4 space-time streams |
| | | | | Values 5-7 are reserved |
| | | | | For a VHT SU PPDU: |
| | | | | B10-B12 |
| | | | | Set to 0 for 1 space-time stream |
| | | | | Set to 1 for 2 space-time streams |
| | | | | Set to 2 for 3 space-time streams |
| | | | | Set to 3 for 4 space-time streams |
| | | | | Set to 4 for 5 space-time streams |
| | | | | Set to 5 for 6 space-time streams |
| | | | | Set to 6 for 7 space-time streams |
| | | | | Set to 7 for 8 space-time streams |
| | | | | B13-B21 |
| | | | | Partial AID: Set to the value of the TXVECTOR |
| | | | | parameter PARTIAL_AID. Partial AID provides an |
| | | | | abbreviated indication of the intended recipient(s) of the |
| | | | | PSDU (see 9.17a). |
| | B22 | TXOP_PS_{—} | 1 | Set to 0 by VHT AP if it allows non-AP VHT STAs in |
| | | NOT_ALLOWED | | TXOP power save mode to enter Doze state during a TXOP. |
| | | | | Set to 1 otherwise. |
| | | | | The bit is reserved and set to 1 in VHT PPDUs transmitted |
| | | | | by a non-AP VHT STA. |
| | B23 | Reserved | 1 | Set to 1 |
| VHT-SIG-A2 | B0 | Short GI | 1 | Set to 0 if short guard interval is not used in the Data field. |
| | | | | Set to 1 if short guard interval is used in the Data field. |
| | B1 | Short GI | 1 | Set to 1 if short guard interval is used and N_{SYM} mod 10 = 9; |
| | | N_{SYM} | | otherwise, set to 0. N_{SYM} is defined in 22.4.3. |
| | | Disambiguation | | |
| | B2 | SU/MU[0] | 1 | For a VHT SU PPDU, B2 is set to 0 for BCC, 1 for LDPC |
| | | Coding | | For a VHT MU PPDU, if the MU[0] NSTS field is nonzero, |
| | | | | then B2 indicates the coding used for user u with |
| | | | | USER_POSITION[u] = 0; set to 0 for BCC and 1 for LDPC. |
| | | | | If the MU[0] NSTS field is 0, then this field is reserved and |
| | | | | set to 1. |
| | B3 | LDPC Extra | 1 | Set to 1 if the LDPC PPDU encoding process (if an SU |
| | | OFDM | | PPDU), or at least one LDPC user's PPDU encoding process |
| | | Symbol | | (if a VHT MU PPDU), results in an extra OFDM symbol (or |
| | | | | symbols) as described in 22.3.10.5.4 and 22.3.10.5.5. Set to |
| | | | | 0 otherwise. |
| | B4-B7 | SU VHT-MCS/MU[1- | 4 | For a VHT SU PPDU: |
| | | 3] Coding | | VHT-MCS index |
| | | | | For a VHT MU PPDU: |
| | | | | If the MU[1] NSTS field is nonzero, then B4 indicates |
| | | | | coding for user u with USER_POSITION[u] = 1: set to 0 |
| | | | | for BCC, 1 for LDPC. If the MU[1] NSTS field is 0, then |
| | | | | B4 is reserved and set to 1. |
| | | | | If the MU[2] NSTS field is nonzero, then B5 indicates |
| | | | | coding for user u with USER_POSITION[u] = 2: set to 0 |
| | | | | for BCC, 1 for LDPC. If the MU[2] NSTS field is 0, then |
| | | | | B5 is reserved and set to 1. |
| | | | | If the MU[3] NSTS field is nonzero, then B6 indicates |
| | | | | coding for user u with USER_POSITlON[u] = 3: set to 0 |
| | | | | for BCC, 1 for LDPC. If the MU[3] NSTS field is 0, then |
| | | | | B6 is reserved and set to 1. |
| | | | | B7 is reserved and set to 1 |
| | B8 | Beamformed | 1 | For a VHT SU PPDU: |
| | | | | Set to 1 if a Beamforming steering matrix is applied to the |
| | | | | waveform in an SU transmission as described in |
| | | | | 20.3.11.11.2, set to 0 otherwise. |
| | | | | For a VHT MU PPDU: |
| | | | | Reserved and set to 1 |
| | | | | NOTE-If equal to 1 smoothing is not recommended. |
| | B9 | Reserved | 1 | Reserved and set to 1 |
| | B10-B17 | CRC | 8 | CRC calculated as in 20.3.9.4.4 with c7 in B10. Bits 0-23 of |
| | | | | HT-SIG1 and bits 0-9 of HT-SIG2 are replaced by bits 0-23 |
| | | | | of VHT-SIG-A1 and bits 0-9 of VHT-SIG-A2, respectively. |
| | B18-B23 | Tail | 6 | Used to terminate the trellis of the convolutional decoder. |
| | | | | Set to 0. |

[Table 1] illustrates fields, bit positions, numbers of bits, and descriptions included in each of two parts, VHT-SIG-A1 and VHT-SIG-A2, of the VHT-SIG-A field defined by the IEEE 802.11ac standard. For example, a BW (BandWidth) field occupies two Least Significant Bits (LSBs), B0 and B1 of the VHT-SIG-A1 field and has a size of 2 bits. If the 2 bits are set to 0, 1, 2, or 3, the BW field indicates 20 MHz, 40 MHz, 80 MHz, or 160 and 80+80 MHz. For details of the fields included in the VHT-SIG-A field, refer to the IEEE 802.11ac-2013 technical specification. In the HE PPDU frame format of the present invention, the HE-SIG-A field may include one or more of the fields included in the VHT-SIG-A field, and it may provide backward compatibility with IEEE 802.11ac stations.

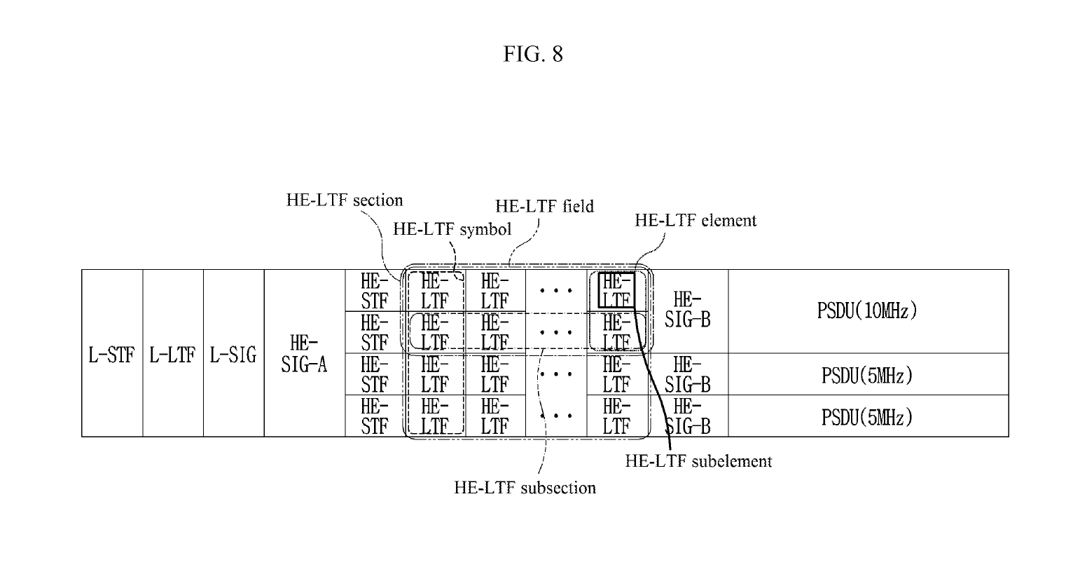

FIG. 8 depicts subchannel allocation in the HE PPDU frame format according to the present invention.

In the example of FIG. 8, it is assumed that information indicating subchannels to which STAs are allocated in HE PPDU indicates that a subchannel of 0 MHz is allocated to STA1 (i.e., no subchannel is allocated), a subchannel of 5 MHz is allocated to each of STA2 and STA3, and a subchannel of 10 MHz is allocated to STA4.

In the example of FIG. 8, an L-STF, an L-LTF, an L-SIG, and a HE-SIG-A may be transmitted per channel (e.g., 20 MHz), a HE-STF and a HE-LTF may be transmitted on each of subchannels being basic subchannel units (e.g., 5 MHz), and a HE-SIG-B and a PSDU may be transmitted on each of subchannels allocated to STAs. A subchannel allocated to a STA has a size required for PSDU transmission to the STA. The size of the subchannel allocated to the STA may be an N (N=1, 2, 3, . . . ) multiple of the size of the basic subchannel unit (i.e., a minimum-size subchannel unit). In the example of FIG. 8, the size of a subchannel allocated to STA2 is equal to that of the basic subchannel unit, the size of a subchannel allocated to STA3 is equal to that of the basic subchannel unit, and the size of a subchannel allocated to STA4 is twice larger than that of the basic subchannel unit.

FIG. 8 illustrates a plurality of HE-LTF elements and a plurality of HE-LTF subelements which are distinguished in the time and frequency domains. One HE-LTF element may correspond to one OFDM symbol in the time domain and one subchannel unit (i.e., the bandwidth of a subchannel allocated to a STA) in the frequency domain. One HE-LTF subelement may correspond to one OFDM symbol in the time domain and one basic subchannel unit (e.g. 5 MHz) in the frequency domain. In the example of FIG. 8, one HE-LTF element includes one HE-LTF subelement in the 5-MHz subchannel allocated to STA2 or STA3. On the other hand, one HE-LTF element includes two HE-LTF subelements in the third subchannel, i.e., 10-MHz subchannel, allocated to STA4. It is to be understood that a HE-LTF element and a HE-LTF subelement are logical units and the PHY layer does not always operate in units of a HE-LTF element or HE-LTF subelement.

A HE-LTF symbol may correspond to a set of HE-LTF elements in one OFDM symbol in the time domain and one channel unit (e.g. 20 MHz) in the frequency domain. That is, one HE-LTF symbol may be divided into HE-LTF elements by a subchannel width allocated to a STA and into HE-LTF subelements by the width of the basic subchannel unit in the frequency domain.

A HE-LTF section may correspond to a set of HE-LTF elements in one or more OFDM symbols in the time domain and one subchannel unit (i.e. the bandwidth of a subchannel allocated to a STA) in the frequency domain. A HE-LTF subsection may correspond to a set of HE-LTF elements in one or more OFDM symbols in the time domain and one basic subchannel unit (e.g., 5 MHz) in the frequency domain. In the example of FIG. 8, one HE-LTF section includes one HE-LTF subsection in the 5-MHz subchannel allocated to STA2 or STA3. On the other hand, one HE-LTF section includes two HE-LTF subsections in the third subchannel, i.e., 10-MHz subchannel, allocated to STA4.

A HE-LTF field may correspond to a set of HE-LTF elements (or subelements), HE-LTF symbols, or HE-LTF sections (or subsections) for a plurality of stations.

For the afore-described HE PPDU transmission, subchannels allocated to a plurality of HE STAs may be contiguous in the frequency domain. In other words, for HE PPDU transmission, the subchannels allocated to the HE STAs may be sequential and any intermediate one of the subchannels of one channel (e.g., 20 MHz) may not be allowed to be unallocated or empty. Referring to FIG. 7, if one channel includes four subchannels, it may not be allowed to keep the third subchannel unallocated and empty, while the first, second, and fourth subchannels are allocated to STAs. However, the present invention does not exclude non-allocation of a intermediate subchannel of one channel to a STA.

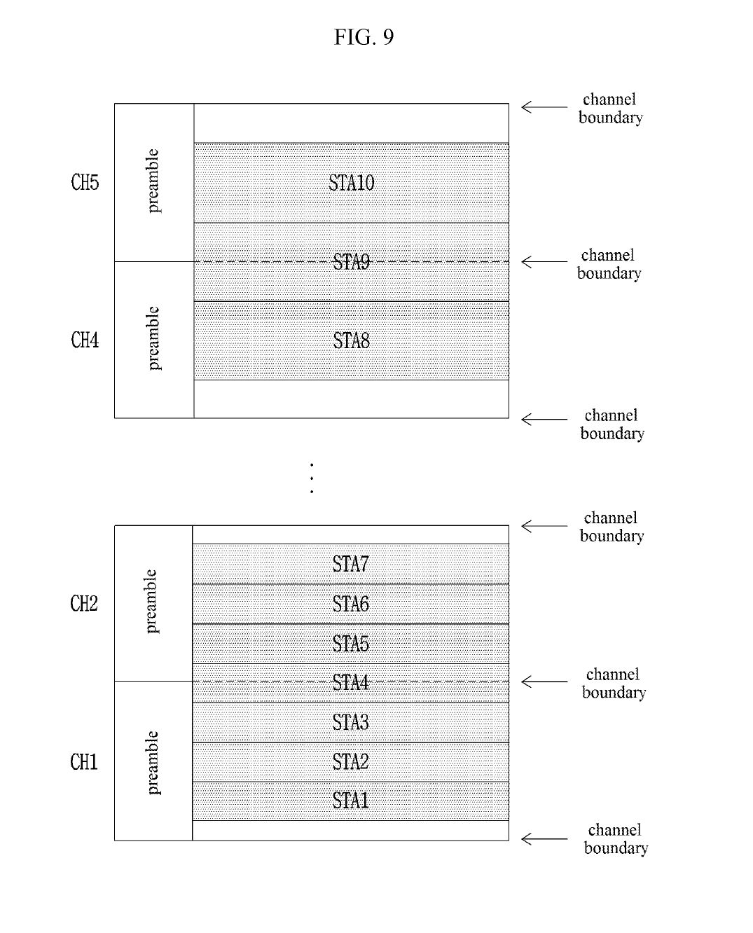

FIG. 9 depicts a subchannel allocation method according to the present invention.

In the example of FIG. 9, a plurality of contiguous channels (e.g., 20-MHz-bandwidth channels) and boundaries of the plurality of contiguous channels are shown. In FIG. 9, a preamble may correspond to an L-STF, an L-LTF, an L-SIG, and a HE-SIG-A as illustrated in the examples of FIGS. 7 and 8.

A subchannel for each HE STA may be allocated only within one channel, and may not be allocated with partially overlapping between a plurality of channels. That is, if there are two contiguous 20-MHz channels CH1 and CH2, subchannels for STAs paired for MU-MIMO-mode or OFDMA-mode transmission may be allocated either within CH1 or within CH2, and it may be prohibited that one part of a subchannel exists in CH1 and another part of the subchannel exists in CH2. This means that one subchannel may not be allocated with crossing a channel boundary. From the perspective of RUs supporting the MU-MIMO or OFDMA mode, a bandwidth of 20 MHz may be divided into one or more RUs, and a bandwidth of 40 MHz may be divided into one or more RUs in each of two contiguous 20-MHz bandwidths, and no RU is allocated with crossing the boundary between two contiguous 20-MHz bandwidths.

As described above, it is not allowed that one subchannel belongs to two or more 20-MHz channels. Particularly, a 2.4-GHz OFDMA mode may support a 20-MHz OFDMA mode and a 40-MHz OFDMA mode. In the 2.4-GHz OFDMA mode, it may not be allowed that one subchannel belongs to two or more 20-MHz channels.

FIG. 9 is based on the assumption that subchannels each having the size of a basic subchannel unit (e.g., 5 MHz) in CH1 and CH2 are allocated to STA1 to STA7, and subchannels each having double the size (e.g., 10 MHz) of the basic subchannel unit in CH4 and CH5 are allocated to STA8, STA9, and STA10.

As illustrated in the lower part of FIG. 9, although a subchannel allocated to STA1, STA2, STA3, STA5, STAG, or STA7 is fully overlapped only with one channel (i.e., without crossing the channel boundary, or belonging only to one channel), a subchannel allocated to STA4 is partially overlapped with the two channels (i.e., crossing the channel boundary, or belonging to the two channels). In the forgoing example of the present invention, the subchannel allocation to STA4 is not allowed.

As illustrated in the upper part of FIG. 9, although a subchannel allocated to STA8 or STA10 is fully overlapped only with one channel (i.e., crossing the channel boundary, or belonging only to one channel), a subchannel allocated to STA9 is partially overlapped with two channels (i.e., crossing the channel boundary, or belonging to the two channels). In the forgoing example of the present invention, the subchannel allocation to STA9 is not allowed.

On the other hand, it may be allowed to allocate a subchannel partially overlapped between a plurality of channels (i.e., crossing the channel boundary, or belonging to two channels). For example, in SU-MIMO mode transmission, a plurality of contiguous channels may be allocated to a STA and any of one or more subchannels allocated to the STA may cross the boundary between two contiguous channels.

While the following description is given with an assumption that one subchannel has a channel bandwidth of 5 MHz in one channel having a channel bandwidth of 20 MHz, this is provided to simplify the description of the principle of the present invention and thus should not be construed as limiting the present invention. For example, the bandwidths of a channel and a subchannel may be defined or allocated as values other than the above examples. In addition, a plurality of subchannels in one channel may have the same or different channel widths.

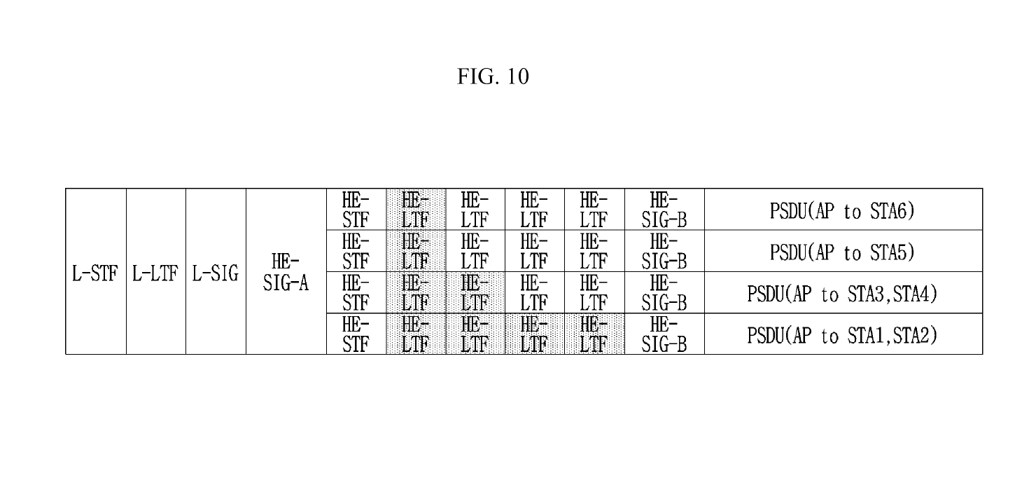

FIG. 10 depicts the starting and ending points of a HE-LTF field in the HE PPDU frame format according to the present invention.

To support the MU-MIMO mode and the OFDMA mode, the HE PPDU frame format according to the present invention may include, in the HE-SIG-A field, information about the number of spatial streams to be transmitted to a HE STA allocated to each subchannel.

If MU-MIMO-mode or OFDMA-mode transmission is performed to a plurality of HE STAs on one subchannel, the number of spatial streams to be transmitted to each of the HE STAs may be provided in the HE-SIG-A or HE-SIG-B field, which will be described later in detail.

FIG. 10 is based on the assumption that a first 5-MHz subchannel is allocated to STA1 and STA2 and two spatial streams are transmitted to each STA in a DL MU-MIMO or OFDMA mode (i.e., a total of four spatial streams are transmitted on one subchannel). For this purpose, a HE-STF, a HE-LTF, a HE-LTF, a HE-LTF, a HE-LTF, and a HE-SIG-B follow the HE-SIG-A field on the subchannel. The HE-STF is used for frequency offset estimation and phase offset estimation for the 5-MHz subchannel. The HE-LTFs are used for channel estimation for the 5-MHz subchannel. Since the subchannel carries four spatial streams, as many HE-LTFs (i.e., HE-LTF symbols or HE-LTF elements in a HE-LTF section) as the number of the spatial streams, that is, four HE-LTFs are required to support MU-MIMO transmission.

According to an example of the present invention, a relationship between a number of total spatial streams transmitted in one subchannel and a number of HE-LTF are listed in [Table 2].

TABLE 2

| Total number of spatial streams | Number of |
|---|---|
| transmitted on one subchannel | HE-LTFs |
| 1 | 1 |
| 2 | 2 |
| 3 | 4 |
| 4 | 4 |
| 5 | 6 |
| 6 | 6 |
| 7 | 8 |
| 8 | 8 |

Referring to [Table 2], if one spatial stream is transmitted on one subchannel, at least one HE-LTF needs to be transmitted on the subchannel. If an even number of spatial streams are transmitted on one subchannel, at least as many HE-LTFs as the number of the spatial streams need to be transmitted. If an odd number of spatial streams greater than one are transmitted on one subchannel, at least as many HE-LTFs as a number of adding 1 to the number of the spatial streams need to be transmitted.

Referring to FIG. 10 again, it is assumed that the second 5-MHz subchannel is allocated to STA3 and STA4 and one spatial streams per STA is transmitted in the DL MU-MIMO or OFDMA mode (i.e., a total of two spatial streams are transmitted on one subchannel). In this case, two HE-LTFs need to be transmitted on the second subchannel, however, in the example of FIG. 10, a HE-STF, a HE-LTF, a HE-LTF, a HE-LTF, a HE-LTF, and a HE-SIG-B follow the HE-SIG-A field on the subchannel (i.e., four HE-LTFs are transmitted). This is for setting the same starting time of PSDU transmission for subchannels allocated to other STAs paired with STA3 and STA4 for MU-MIMO transmission. If only two HE-LTFs are transmitted on the second subchannel, PSDUs are transmitted at different time points on the first and second subchannels. PSDU transmission on each subchannel at a different time point results in discrepancy between OFDM symbol timings of subchannels, thereby no orthogonality is maintained. To overcome this problem, an additional constraint need to be imposed for HE-LTF transmission.

Basically, transmission of as many HE-LTFs as required is sufficient in an SU-MIMO or non-OFDMA mode. However, timing synchronization (or alignment) with fields transmitted on subchannels for other paired STAs is required in the MU-MIMO or OFDMA mode. Accordingly, the numbers of HE-LTFs may be determined for all other subchannels based on a subchannel having the maximum number of streams in MU-MIMO-mode or OFDMA-mode transmission.

Specifically, the numbers of HE-LTFs may be determined for all subchannels according to the maximum of the numbers of HE-LTFs (HE-LTF symbols or HE-LTF elements in a HE-LTF section) required according to the total numbers of spatial streams transmitted on each subchannel, for a set of HE STAs allocated to each subchannel. A “set of HE STAs allocated to each subchannel” is one HE STA in the SU-MIMO mode, and a set of HE STAs paired across a plurality of subchannels in the MU-MIMO mode. The ‘number of spatial streams transmitted on each subchannel’ is the number of spatial streams transmitted to one HE STA in the SU-MIMO mode, and the number of spatial streams transmitted to a plurality of HE STAs paired on the subchannel in the MU-MIMO mode.

That is, it may be said that a HE-LTF field starts at the same time point and ends at the same time point in a HE PPDU for all users (i.e. HE STAs) in MU-MIMO-mode or OFDMA-mode transmission. Or it may be said that the lengths of HE-LTF sections are equal on a plurality of subchannels for all users (i.e. HE STAs) in MU-MIMO-mode or OFDMA-mode transmission. Or it may be said that the number of HE-LTF elements included in each HE-LTF section is equal on a plurality of subchannels for all users (i.e. HE STAs) in MU-MIMO-mode or OFDMA-mode transmission. Accordingly, PSDU transmission timings may be synchronized among a plurality of subchannels for all HE STAs in MU-MIMO-mode or OFDMA-mode transmission.

As described above, the number of HE-LTF symbols (refer to FIG. 7) may be 1, 2, 4, 6, or 8 in HE PPDU transmission in the MU-MIMO or OFDMA mode, determined according to the maximum of the numbers of spatial streams on each of a plurality of subchannels. A different number of spatial streams may be allocated to each of a plurality of subchannels, and the number of spatial streams allocated to one subchannel is the number of total spatial streams for all users allocated to the subchannel. That is, the number of HE-LTF symbols may be determined according to the number of spatial streams allocated to a subchannel having a maximum number of spatial streams by comparing the number of total spatial streams for all users allocated to one of a plurality of subchannels with the number of total spatial streams for all users allocated to another subchannel.

Specifically, in HE PPDU transmission in the OFDMA mode, the number of HE-LTF symbols may be 1, 2, 4, 6, or 8, determined based on the number of spatial streams transmitted in a subchannel having a maximum number of spatial streams across a plurality of subchannels. Further, in HE PPDU transmission in the OFDMA mode, the number of HE-LTF symbols may be determined based on whether the number of spatial streams transmitted in a subchannel having a maximum number of spatial streams across a plurality of subchannels is odd or even (refer to [Table 3]). That is, in HE PPDU transmission in the OFDMA mode, when the number (e.g., K) of spatial streams transmitted in a subchannel having a maximum number of spatial streams across a plurality of subchannels is an even number, the number of HE-LTF symbols may be equal to K. In HE PPDU transmission in the OFDMA mode, when the number, K, of spatial streams transmitted in a subchannel having a maximum number of spatial streams across a plurality of subchannels is an odd number greater than one, the number of HE-LTF symbols may be equal to K+1.

When only one STA is allocated to one subchannel in OFDMA mode (i.e., OFDMA mode without using MU-MIMO), a subchannel having a maximum number of spatial streams across a plurality of subchannels may be determined by the number of spatial streams for a STA allocated to each subchannel. When more than one STA is allocated to one subchannel in OFDMA mode (i.e., OFDMA mode using MU-MIMO), a subchannel having a maximum number of spatial streams across a plurality of subchannels may be determined by the number of STAs allocated to each subchannel and the number of spatial streams for each STA allocated to each subchannel (e.g., if STA1 and STA2 are allocated to one subchannel, sum of the number of spatial streams for STA1 and the number of spatial streams for STA2).

When transmitting a HE PPDU frame in the MU-MIMO or OFDMA mode, a transmitter may generate P (P is an integer equal to or larger than 1) HE-LTF symbols (refer to FIG. 7) and transmit a HE PPDU frame including at least the P HE-LTF symbols and a Data field to a receiver. The HE PPDU frame may be divided into Q subchannels in the frequency domain (Q is an integer equal to or larger than 2). Each of the P HE-LTF symbols may be divided into Q HE-LTF elements corresponding to the Q subchannels in the frequency domain. That is, the HE PPDU may include P HE-LTF elements on one subchannel (herein, the P HE-LTF elements may belong to one HE-LTF section on the subchannel).

As described above, the number of HE-LTF elements (i.e., P) in one of the Q subchannels may be equal to the number of HE-LTF elements (i.e. P) of another subchannel. Also, the number of HE-LTF elements (i.e., P) included in a HE-LTF section in one of the Q subchannels may be equal to the number of HE-LTF elements (i.e. P) included in a HE-LTF section in another subchannel. The HE-LTF section of one of the Q subchannels may start and end at the same time points as the HE-LTF section of another subchannel. Also, the HE-LTF sections may start and end at the same time points across the Q subchannels (i.e., across all users or stations).

Referring to FIG. 10 again, the third 5-MHz subchannel is allocated to STA5 and one spatial stream is transmitted on the subchannel in SU-MIMO (considering all subchannels, a plurality of spatial streams are transmitted to STA1 to STAG in MU-MIMO or OFDMA mode). In this case, although transmission of one HE-LTF is sufficient for the subchannel, as many HE-LTFs as the maximum of the numbers of HE-LTFs on the other subchannels, that is, four HE-LTFs are transmitted on the subchannel in order to align the starting points and ending points of the HE-LTF fields of the subchannels.

The fourth 5-MHz subchannel is allocated to STA6 and one spatial stream is transmitted on the subchannel in SU-MIMO (considering all other subchannels, a plurality of spatial streams are transmitted to STA1 to STA6 in MU-MIMO or OFDMA mode). In this case, although transmission of one HE-LTF is sufficient for the subchannel, as many HE-LTFs as the maximum of the numbers of HE-LTFs on the other subchannels, that is, four HE-LTFs are transmitted on the subchannel in order to align the starting points and ending points of the HE-LTF fields of the subchannels.

In the example of FIG. 10, the remaining two HE-LTFs except two HE-LTFs required for channel estimation of STA3 and STA4 on the second subchannel, the remaining three HE-LTFs except one HE-LTF required for channel estimation of STA5 on the third subchannel, and the remaining three HE-LTFs except one HE-LTF required for channel estimation of STA6 on the fourth subchannel may be said to be placeholders that are actually not used for channel estimation at the STAs.

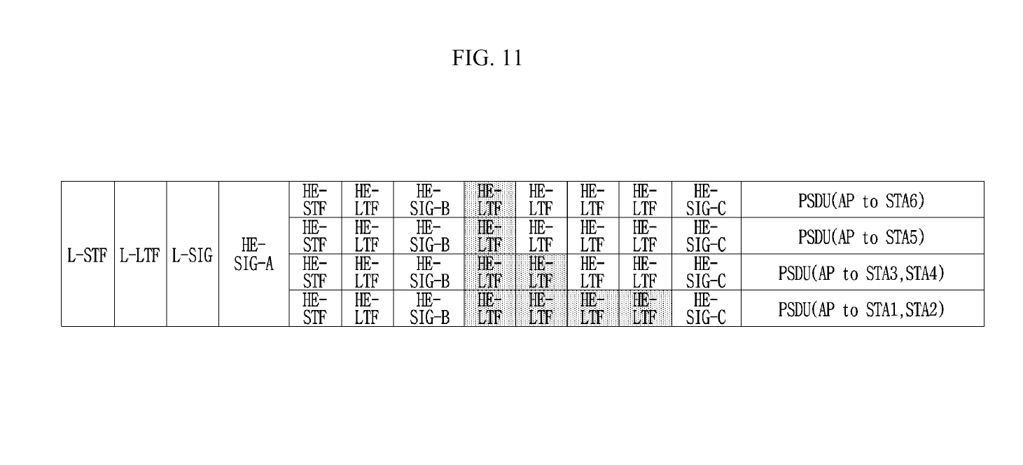

FIG. 11 depicts a HE-SIG-B field and a HE-SIG-C field in the HE PPDU frame format according to the present invention.

To effectively support MU-MIMO-mode or OFDMA-mode transmission in the HE PPDU frame format according to the present invention, independent signaling information may be transmitted on each subchannel. Specifically, a different number of spatial streams may be transmitted to each of a plurality of HE STAs that receive an MU-MIMO-mode or OFDMA-mode transmission simultaneously. Therefore, information about the number of spatial streams to be transmitted should be indicated to each HE STA.

Information about the number of spatial streams on one channel may be included in, for example, a HE-SIG-A field. A HE-SIG-B field may include spatial stream allocation information about one subchannel. Also, a HE-SIG-C field may be transmitted after transmission of HE-LTFs, including MCS information about a PSDU and information about the length of the PSDU, etc.

With reference to the foregoing examples of the present invention, mainly the features of a HE PPDU frame structure applicable to a DL MU-MIMO-mode or OFDMA-mode transmission that an AP transmits simultaneously to a plurality of STAs have been described. Now, a description will be given of the features of a HE PPDU frame structure applicable to a UL MU-MIMO-mode or OFDMA-mode transmission that a plurality of STAs transmits simultaneously to an AP.

The above-described various examples of structures of the HE PPDU frame format supporting MU-MIMO-mode or OFDMA-mode transmission should not be understood as applicable only to DL without applicable UL. Rather, the examples should be understood as also applicable to UL. For example, the above-described exemplary HE PPDU frame formats may also be used for a UL HE PPDU transmission that a plurality of STAs simultaneously transmits to a single AP.

However, in the case of a DL MU-MIMO-mode or OFDMA-mode HE PPDU transmission that an AP simultaneously transmits to a plurality of STAs, the transmission entity, AP has knowledge of the number of spatial streams transmitted to a HE STA allocated to each of a plurality of subchannels. Therefore, the AP may include, in a HE-SIG-A field or a HE-SIG-B field, information about the total number of spatial streams transmitted across a channel, a maximum number of spatial streams (i.e., information being a basis of the number of HE-LTF elements (or the starting point and ending point of a HE-LTF section) on each subchannel), and the number of spatial streams transmitted on each subchannel. In contrast, in the case of a UL MU-MIMO-mode or OFDMA-mode HE PPDU transmission that a plurality of STAs simultaneously transmits to an AP, each STA being a transmission entity may be aware only of the number of spatial streams in a HE PSDU that it will transmit, without knowledge of the number of spatial streams in a HE PSDU transmitted by another STA paired with the STA. Accordingly, the STA may determine neither the total number of spatial streams transmitted across a channel nor a maximum number of spatial streams.

To solve this problem, a common parameter (i.e., a parameter applied commonly to STAs) and an individual parameter (a separate parameter applied to an individual STA) may be configured as follows in relation to a UL HE PPDU transmission.

For simultaneous UL HE PPDU transmissions from a plurality of STAs to an AP, a protocol may be designed in such a manner that the AP sets a common parameter or individual parameters (common/individual parameters) for the STAs for the UL HE PPDU transmissions and each STA operates according to the common/individual parameters. For example, the AP may transmit a trigger frame (or polling frame) for a UL MU-MIMO-mode or OFDMA-mode transmission to a plurality of STAs. The trigger frame may include a common parameter (e.g., the number of spatial streams across a channel or a maximum number of spatial streams) and individual parameters (e.g., the number of spatial streams allocated to each subchannel), for the UL MU-MIMO-mode or OFDMA-mode transmission. As a consequence, a HE PPDU frame format applicable to a UL MU-MIMO or OFDMA mode may be configured without a modification to an exemplary HE PPDU frame format applied to a DL MU-MIMO or OFDMA mode. For example, each STA may configure a HE PPDU frame format by including information about the number of spatial streams across a channel in a HE-SIG-A field, determining the number of HE-LTF elements (or the starting point and ending point of a HE-LTE section) on each subchannel according to the maximum number of spatial streams, and including information about the number of spatial streams for the individual STA in a HE-SIG-B field.

Alternatively, if the STAs operate always according to the common/individual parameters received in the trigger frame from the AP, each STA does not need to indicate the common/individual parameters to the AP during a HE PPDU transmission. Therefore, this information may not be included in a HE PPDU. For example, each STA may have only to determine the total number of spatial streams, the maximum number of spatial streams, and the number of spatial streams allocated to individual STA, as indicated by the AP, and configure a HE PPDU according to the determined numbers, without including information about the total number of spatial streams or the number of spatial streams allocated to the STA in the HE PPDU.

On the other hand, if the AP does not provide common/individual parameters in a trigger frame, for a UL MIMO-mode or OFDMA-mode HE PPDU transmission, the following operation may be performed.

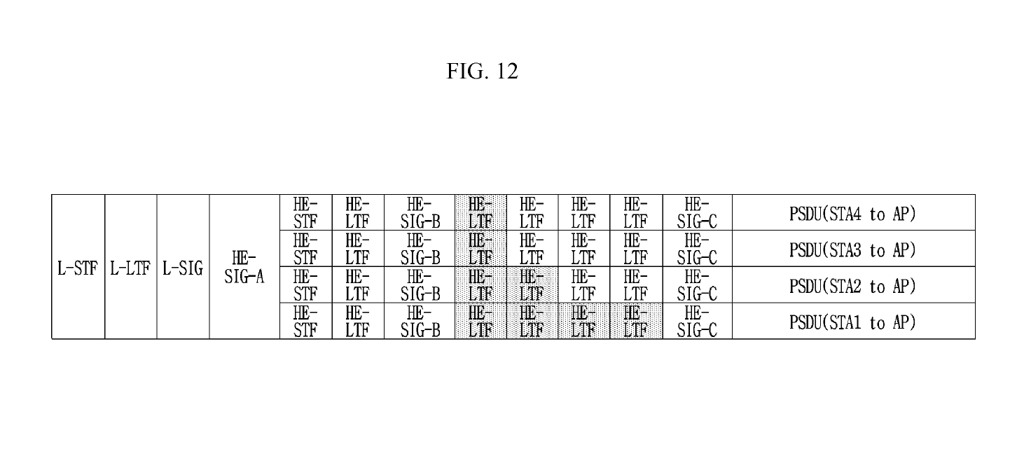

Common transmission parameters (e.g., channel BandWidth (BW) information, etc.) for simultaneously transmitted HE PSDUs may be included in HE-SIG-A field, but parameters that may be different for individual STAs (e.g., the number of spatial streams, an MCS, and whether STBC is used or not, for each individual STA) may not be included in HE-SIG-A field. Although the individual parameters may be included in HE-SIG-B field, information about the number of spatial streams and information indicating whether STBC is used or not, need to be transmitted before a HE-LTF field because the number of spatial streams and the information indicating whether STBC is used or not are significant to determination of configuration information about a preamble and a PSDU in a HE PPDU frame format (e.g., the number of HE-LTF elements is determined according to a combination of the number of spatial streams and the information indicating whether STBC is used or not). For this purpose, a HE PPDU frame format as illustrated in FIG. 12 may be used for a UL HE PPDU transmission.

FIG. 12 depicts another exemplary HE PPDU frame format according to the present invention. The HE PPDU frame format illustrated in FIG. 12 is characterized in that a structure of HE-SIG-A, HE-SIG-B, and HE-SIG-C fields similar to in FIG. 10 is used for a UL PPDU transmission.

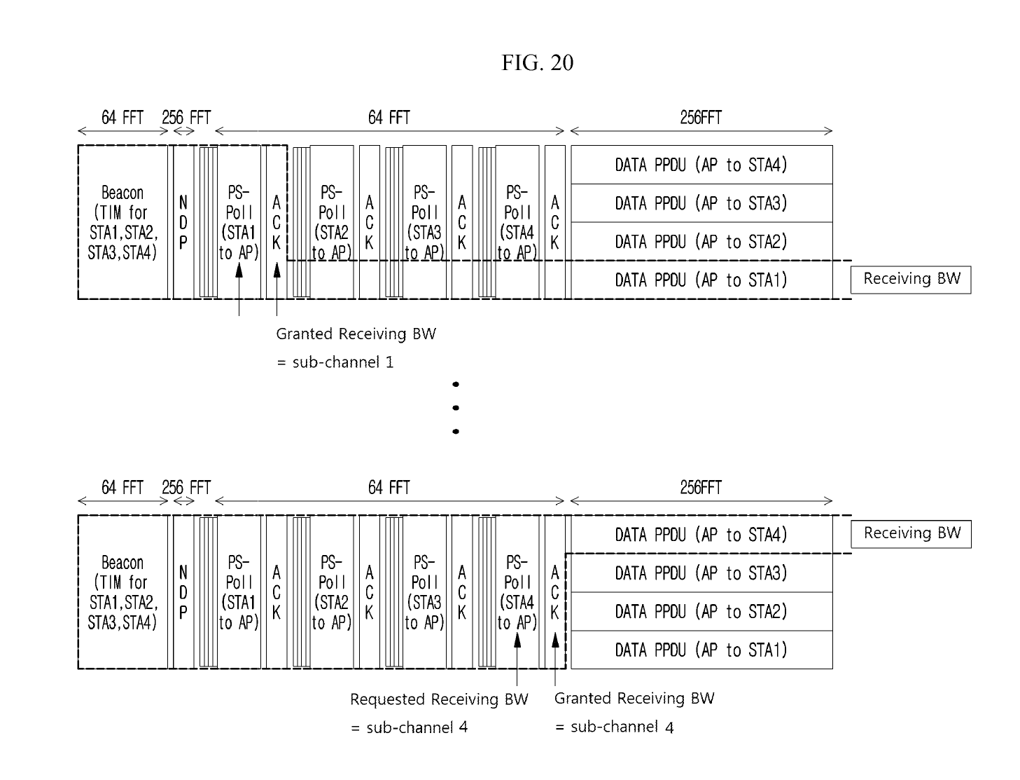

As described before, if a UL MU-MIMO-mode or OFDMA-mode transmission is performed by triggering of an AP (according to common/individual parameters provided by the AP), an individual STA may not need to report an individual parameter to the AP. In this case, one or more of a HE-SIG-B field, a HE-SIG-C field, and a first HE-LTF element (i.e., a HE-LTF between a HE-STF field and a HE-SIG-B field) illustrated in FIG. 12 may not exist (e.g., a HE PPDU frame format of FIG. 20, which should not be construed as limiting the present invention). In this case, a description of each field given below may be understood that it is applied only in the presence of the field.

In the example of FIG. 12, a HE-SIG-A field is transmitted per channel (i.e., per 20-MHz channel) and may include transmission parameters common to simultaneously transmitted HE PSDUs. Since the same information is transmitted in up to HE-SIG-A fields in UL PPDUs transmitted by HE STAs allocated to subchannels, the AP may receive the same signals from the plurality of STAs successfully.

A HE-SIG-B field is transmitted per subchannel in one channel. The HE-SIG-B field may have an independent parameter value according to the transmission characteristics of a HE PSDU transmitted on each subchannel. The HE-SIG-B field may include spatial stream allocation information and information indicating whether STBC is used or not, for each subchannel. If MU-MIMO is applied to a subchannel (i.e., if a plurality of STAs perform transmission on a subchannel), the HE-SIG-B field may include a common parameter for the plurality of STAs paired on the subchannel.

A HE-SIG-C field is transmitted on the same subchannel as the HE-SIG-B field and may include information about an MCS and a packet length. If MU-MIMO is applied to a subchannel (i.e., if a plurality of STAs perform transmission on a subchannel), the HE-SIG-C field may include respective individual parameters for each of the plurality of STAs paired on the subchannel.

Similarly to DL MU-MIMO-mode or OFDMA-mode HE PPDU transmission, transmissions of PSDUs may start at different time points on subchannels in UL MU-MIMO-mode or OFDMA-mode HE PPDU transmission, and if OFDM symbols are not aligned accordingly, then the implementation complexity of an AP that receives a plurality of PSDUs increased. To solve this problem, ‘the number of HE-LTFs may be determined for all subchannels according to the maximum of the numbers of HE LTFs required according to the total numbers of spatial streams transmitted on each subchannel for a set of HE STAs allocated to each of subchannels’ as described with reference to the example of FIG. 10.

This feature may mean that the HE-LTF field start at the same time point and end at the same time point across all users (i.e., HE STAs) in UL MU-MIMO-mode or OFDMA-mode transmission. Or it may be said that the HE-LTF sections of a plurality of subchannels have the same length across all HE STAs in UL MU-MIMO-mode or OFDMA-mode transmission. Or it may be said that each of the HE-LTF sections of a plurality of subchannels includes the same number of HE-LTF elements across all HE STAs in UL MU-MIMO-mode or OFDMA-mode transmission. Therefore, PSDU transmission timings are synchronized between a plurality of subchannels across all HE STAs in UL MU-MIMO-mode or OFDMA-mode transmission.

As described before, a plurality of STAs may simultaneously transmit PSDUs in a HE PPDU frame format to an AP on subchannels allocated to the STAs (i.e., referred to as UL MU-MIMO or OFDMA transmission or “UL MU transmission”), and a plurality of STAs may simultaneously receive a PSDU in a HE PPDU frame format from an AP on subchannels allocated to the STAs (i.e., referred to as DL MU-MIMO or OFDMA transmission or “DL MU transmission”).

Now, a description will be given of an exemplary ACK procedure of a receiver (i.e., an AP) in response to a UL MU-MIMO or OFDMA transmission and an exemplary ACK procedure of a receiver (i.e., each of a plurality of STAs) in response to a DL MU-MIMO or OFDMA transmission according to the present invention.

According to the present invention, ACK frames transmitted in response to an MU transmission for a plurality of STAs may have the same property for each of the STAs. Specifically, ACK frames transmitted in response to an MU transmission for a plurality of STAs may have the same length, transmission time, or type for each of the STAs. An AP may transmit DL ACK frames to a plurality of STAs in response to a UL MU transmission and the DL ACK frames for the STAs may have the same property. The plurality of STAs may transmit UL ACK frames to the AP in response to a DL MU transmission and the UL ACK frames from the STAs may have the same property.

Such an MU transmission for a plurality of STAs may be elicited by a trigger frame transmitted from an MU transmission-receiver. For example, the trigger frame may be a CTS frame, a PS-Poll frame, or an ACK frame.

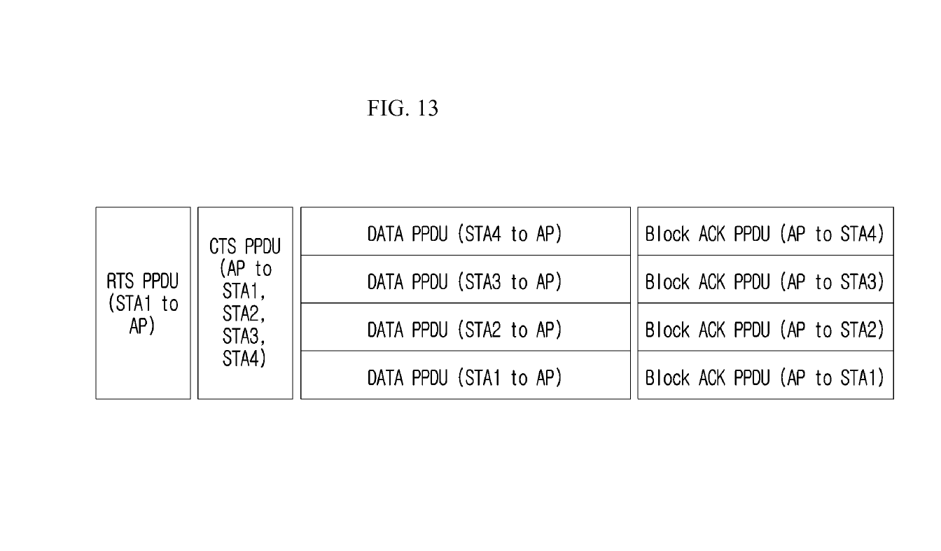

FIG. 13 depicts an exemplary block ACK procedure performed in response to a UL MU transmission according to the present invention.

FIG. 13 illustrates an example in which ACK frames for a UL MU transmission elicited by a trigger frame (i.e., a CTS frame) transmitted from an AP have the same property for each of a plurality of STAs. In FIG. 13, a plurality of STAs respectively transmit data frames (e.g., PPDU frames each including a PSDU, on a plurality of subchannels) on subchannels allocated to the STAs and receive ACKs in block ACK frames from an AP in response to the transmitted data frames.

In the example of FIG. 13, upon expiration of a backoff timer, an STA (e.g., STA1) may transmit an RTS PPDU to the AP according to an Enhanced Distributed Channel Access (EDCA) protocol.

Upon receipt of the RTS PPDU, the AP may determine STAs (e.g., STA2, STA3, and STA4) to perform a UL MU-MIMO or OFDMA transmission simultaneously with STA1 and transmit a CTS PPDU to the plurality of STAs. The CTS PPDU may include a list of STAs (e.g., STA1, STA2, STA3, and STA4) allowed to be allocated to subchannels and perform simultaneous PSDU transmissions on the subchannels. That is, the CTS PPDU may correspond to the afore-described trigger frame (or polling frame) for a UL MU-MIMO or OFDMA transmission.

Upon receipt of an indication allowing a UL MU-MIMO or OFDMA transmission in the CTS PPDU, the STAs transmit PSDUs on their allocated subchannels. In the example of FIG. 13, STA1, STA2, STA3, and STA4 transmit DATA PPDUs respectively on four subchannels. While not shown for clarity of description, the plurality of DATA PPDUs may be transmitted in a HE PPDU frame format in FIG. 13 (e.g., one or more of a L-STF, a L-LTF, a L-SIG, and a HE-SIG-A are transmitted on one channel, one or more of a HE-STF, a HE-LTF, a HE-SIG-B, and a HE-SIG-C are transmitted respectively on each subchannel, and a PSDU is transmitted on each subchannel). That is, a DATA PPDU for an STA allocated to one subchannel is a data frame including one or more of a L-STF, a L-LTF, a L-SIG, and a HE-SIG-A on one channel, one or more of a HE-STF, a HE-LTF, a HE-SIG-B, and a HE-SIG-C on one subchannel, and a PSDU on one subchannel. This may be referred to as a data frame on a subchannel from the perspective of a PSDU (i.e., an MPDU or A-MPDU). Further, a set of the plurality of DATA PSDUs illustrated in FIG. 13 corresponds to a HE PPDU frame including a legacy preamble, a HE preamble, and PSDUs (i.e., MPDUs or A-MPDUs) on a plurality of subchannels and this may be referred to as a data frame on one channel including a plurality of subchannels, from the perspective of PSDUs (i.e., MPDUs or an Aggregate MPDU (A-MPDU)).

Upon receipt of PSDUs on the respective subchannels from the plurality of STAs, the AP may transmit ACKs in response to the received PSDUs, in the form of blocks ACKs on the subchannels in which the PSDUs haven been received. A block ACK procedure is a scheme in which one block ACK frame is used for a plurality of MPDUs instead of individual ACKs for all MPDUs. An MPDU transmitted from the MAC layer to the PHY layer may correspond to a PSDU at the PHY layer (although an MPDU is similar to a PSDU, a plurality of individual MPDUs aggregated into an A-MPDU may be different from the PSDU). The block ACK frame includes a block ACK bitmap and each bit of the block ACK bitmap may indicate reception success/failure (or decoding success/failure) of an individual MPDU. For details of a legacy block ACK procedure, the IEEE 802.11c technical specifications may be referred to.

A detailed configuration of ACK PPDUs on a plurality of subchannels in the example of FIG. 13, may be described in a similar manner to the afore-described detailed configuration of DATA PPDUs on a plurality of subchannels. That is, ACK PPDUs on a plurality of subchannels may collectively correspond to ACK frames constructed in a HE PPDU frame format and may be referred to as an ACK frame on one channel including a plurality of subchannels from the perspective of PSDUs (i.e., MPDUs or an A-MPDU). From the viewpoint of individual ACK PPDUs, each ACK PPDU may be an ACK frame including a legacy preamble transmitted on one channel, and a HE preamble and a PSDU transmitted on one subchannel and may be referred to as an ACK frame on a subchannel from the perspective of a PSDU (i.e., an MPDU or A-MPDU).

As described above, a plurality of block ACK frames that an AP transmits to a plurality of STAs on a plurality of subchannels at the same time may have the same property (e.g., the same length, transmission time, or type).

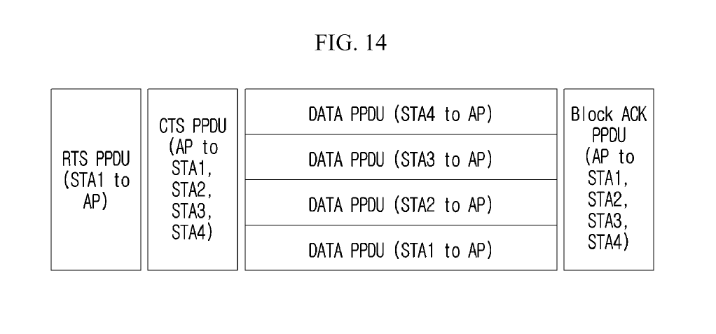

FIG. 14 depicts another exemplary block ACK procedure performed in response to a UL MU transmission according to the present invention.

FIG. 14 illustrates an example in which ACK frames for a UL MU transmission elicited by a trigger frame (i.e. a CTS frame) from an AP have the same property for the plurality of STAs. In the example of FIG. 14, transmission of an RTS PPDU, transmission of a CTS PPDU, and MU-MIMO or OFDMA transmission of a DATA PPDU on an allocated subchannel by each STA are performed in the same manner as in FIG. 13 and thus will not be described to avoid redundancy.

As in the afore-described example of FIG. 13, a procedure for transmitting block ACK PPDUs to a plurality of STAs on a plurality of subchannels in response to a received UL MU-MIMO or OFDMA transmission increases overhead in view of configuration of a different DATA PPDU for each subchannel by the AP. Accordingly, a block ACK for a UL MU-MIMO or OFDMA transmission may be transmitted on total subchannels in the example of FIG. 14.

That is, it may be said that the AP transmits block ACK PPDUs in OFDMA to the individual STAs at the same time in FIG. 13, while the AP multicasts/broadcasts a block ACK PPDU having an aggregate of block ACK bitmaps for the respective STAs on the total subchannels (e.g., on one channel without distinction made between the subchannels, that is, in non-OFDMA). Accordingly, the overhead of the AP may be reduced, compared to generation and transmission of PPDUs on individual subchannels.

In this manner, one block ACK frame that the AP transmits on one channel to the plurality of STAs may have the same property (e.g., the same length, transmission time, or type).

In the foregoing examples of the present invention, if an AP transmits a trigger frame to a plurality of STAs and receives a UL MU frame from the plurality of STAs in response to the trigger frame, the AP may determine a transmission mode for an ACK frame to be transmitted in response to the UL MU frame, based on the UL MU frame. That is, upon receipt of a UL MU frame, the AP may select one of OFDMA (e.g., the example of FIG. 13) and non-OFDMA (e.g., the example of FIG. 14) as the transmission mode of the ACK frame based on information about the UL MU frame (e.g., control information included in the UL MU frame, the transmission mode or type of the UL MU frame, etc.), and generate and transmit an ACK frame according to the determined transmission mode on DL.

An STA may transmit the UL MU frame in response to the trigger frame received from the AP and receive the ACK frame from the AP in response to the UL MU frame. The STA may process the ACK frame according to the transmission mode of the received ACK frame. The transmission mode of the ACK frame may be determined based on the UL MU frame that the STA has transmitted to the AP. For example, if the transmission mode of the ACK frame is OFDMA, the STA may acquire ACK information for the STA by decoding a signal received on a subchannel allocated to the STA. If the transmission mode of the ACK frame is non-OFDMA, the STA may acquire ACK information for the STA by decoding a signal received on an entire channel.

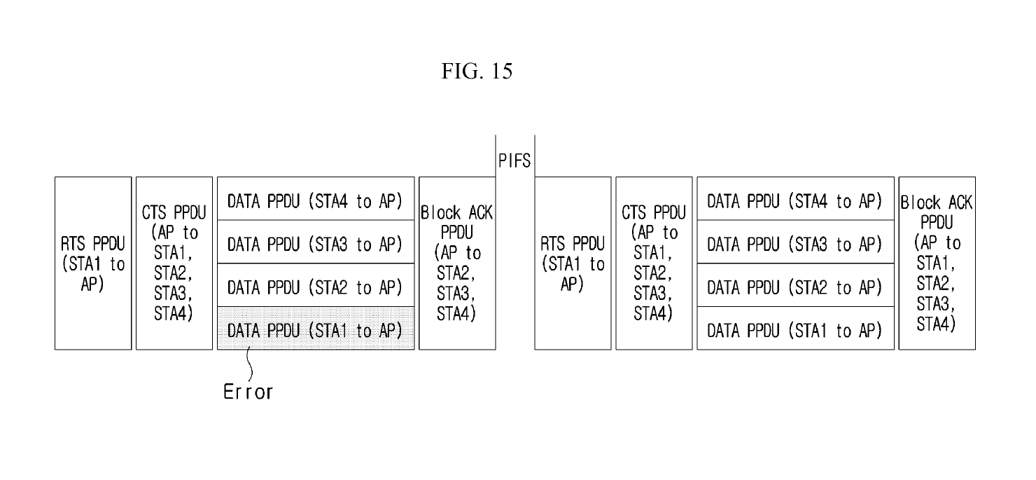

FIG. 15 depicts an error recovery procedure for a UL MU transmission according to the present invention.

The example of FIG. 15 illustrates that in a block ACK scheme in which an AP transmits a block ACK PPDU to all STAs (i.e., a plurality of STAs that have performed a UL MU-MIMO or OFDMA transmission) across entire subchannels (i.e., on one channel as illustrated in FIG. 14), the AP fails to receive data on a subchannel from some (e.g., STA1) of the STAs (i.e. a reception error occurs).

In the example of FIG. 15, upon expiration of a backoff timer, an STA (e.g., STA1) may transmit an RTS PPDU to the AP according to an EDCA protocol, and the AP may transmit a CTS PPDU (a trigger frame or polling frame) to STAs which are allowed to perform a UL MU-MIMO or OFDMA transmission. Therefore, each of the STAs may transmit a DATA PPDU on a subchannel allocated to the STA.

It is assumed that although all of the STAs transmit DATA PPDUs on the respective subchannels allocated to the STAs, the AP successfully receives DATA PPDUs from STA2, STA3, and STA4 on second, third, and fourth subchannels and fails to receive a DATA PPDU from STA1 on a first subchannel. That is, it is assumed that the AP fails to receive a valid PPDU (the AP does not receive a PPDU itself), rather than although the AP receives a valid PPDU from STA1 (e.g., the AP succeeds in a Cyclic Redundancy Code (CRC) check of the received PPDU), the AP fails to receive an MPDU(s) included in the valid PPDU.

As described above, an MU transmission related to a plurality of STAs (e.g., UL OFDMA PSDUs (i.e., MPDUs or A-MPDUs) may be transmitted as a frame responding to a trigger frame (e.g., a CTS frame) (or as a frame elicited by a trigger frame). If an MU receiver (e.g., the AP) successfully receive an MU transmission from at least one STA (i.e., at least one of STAs indicated by the trigger frame), the MU receiver may determine that a frame exchange procedure initiated by the trigger frame is successful and thus may generate an ACK frame.

In this case, the AP may configure a block ACK bitmap only for the received DATA PPDUs (i.e., the DATA PPDUs received from STA2, STA3, and STA4) and transmit the block ACK map to all of the STAs (i.e., all of STA1, STA2, STA3, and STA4) across the entire subchannels (i.e., all of the first to fourth subchannels). That is, although the AP has failed to receive a DATA PPDU from STA1, the presence of the DATA PPDUs received from the other STAs brings about the effect of transmitting the block ACK PPDU even to STA1. In this case, even though STA1 receives the block ACK from the AP, STA1 may not acquire any ACK information for the DATA PPDU that STA1 has transmitted.

In the present invention, in the case where although an STA (e.g., STA1) that has acquired a Transmit Opportunity (TXOP) (i.e., a TXOP owner) transmits a DATA PPDU to the AP and then receives a block ACK PPDU from the AP according to the EDCA protocol, the STA may not acquire any ACK information for its transmitted DATA PPDU as illustrated in the example of FIG. 15, this case may be handled by a PIFS recovery procedure.

According to a conventional PIFS recovery procedure, if a TXOP owner transmits a PPDU and fails to receive an ACK frame in response to the transmitted PPDU during a predetermined time, the TXOP owner determines that a response timeout has occurred and recovers channel access within a TXOP. Upon occurrence of the response timeout, the TXOP owner monitors a wireless medium during a PIFS. If the channel is idle, the TXOP owner may continue the PPDU transmission, and if the channel is busy, the TXOP owner may end the TXOP.

In contrast, according to the present invention, in the case where although a transmitter transmits a PPDU (e.g., a data frame) and receives an ACK frame in response to the PPDU during a specific time period, the transmitter fails to acquire any information for the transmitter (e.g., UE identification information, an ACK bitmap, etc.) in the response frame, the transmitter may determine that the transmission has been failed (i.e., the transmitter may determine that the PPDU transmission (e.g., the data frame transmission) has been failed). Also, if the transmitter receives a response frame in response to a transmitted data frame but the response frame includes no information about the transmitter, the transmitter may determine that it has failed in the data frame transmission and perform a PIFS recovery procedure, considering that a response timeout has occurred despite no actual response timeout. Particularly, if a TXOP owner receives a response frame in response to a PPDU transmitted within a TXOP during a predetermined time period but there is no information about the TXOP owner in the response frame, the TXOP owner may determine that it has failed in the PPDU transmission and perform the PIFS recovery procedure, considering that a response timeout has occurred.

As in the example of FIG. 15, in the case where although STA1 (as a TXOP owner determined by RTS PPDU transmission and CTS PPDU reception) transmits a DATA PPDU to the AP and receives a block ACK PPDU in response to the DATA PPDU from the AP, the block ACK PPDI does not include any information about STA1 (e.g., identification information about STA1, an address of STA1, a block ACK bitmap for STA1, etc.), this corresponds to the transmission failure of the DATA PPDU. Then STA1 monitors a wireless medium during a PIFS. If the channel is idle, STA1 may continue the PPDU transmission, and if the channel is busy, STA1 may end the TXOP.

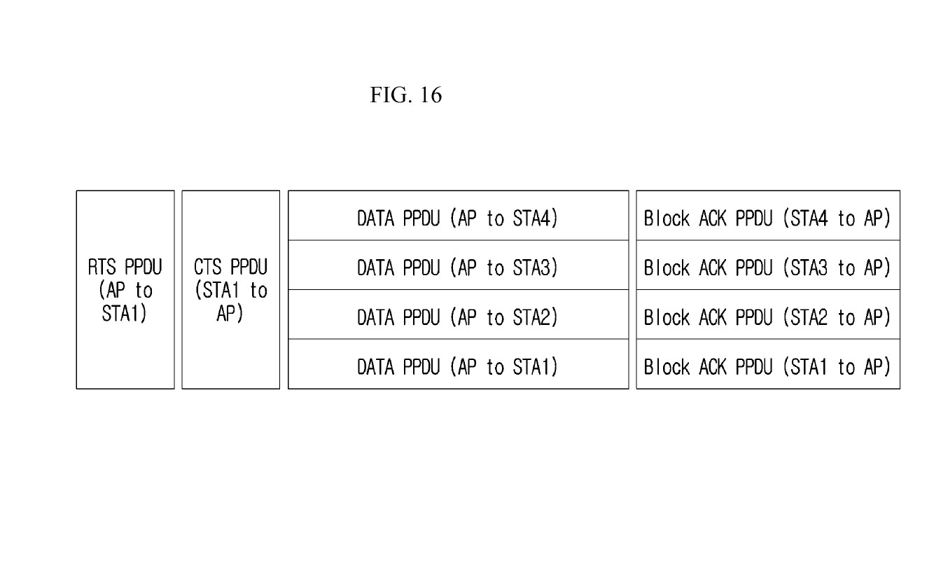

FIG. 16 depicts an exemplary ACK procedure performed in response to a DL MU transmission according to the present invention.

FIG. 16 illustrates an example in which ACK frames transmitted in response to a DL MU transmission triggered by a trigger frame (i.e., a CTS frame) transmitted by an STA have the same property for a plurality of STAs. In FIG. 16, the AP allocates subchannels to the respective STAs, transmits PSDUs simultaneously to the STAs on the subchannels, and receives ACKs in response to the PSDUs, in the form of block ACKs from the plurality of STAs.

In the example of FIG. 16, upon expiration of a backoff timer, the AP may transmit an RTS PPDU to a destination STA (e.g., STA1) according to the EDCA protocol.

Upon receipt of the RTS PPDU, the destination STA (e.g., STA1) may transmit a CTS PPDU to the AP. Upon receipt of the CTS PPDU, the AP may transmit PSDUs simultaneously to a plurality of STAs by allocating subchannels to the respective STAs. The plurality of STAs may include other STAs (e.g., STA2, STA3, and STA4) as well as the destination STA (e.g., STA1) that has exchanged RTS/CTS with the AP. In the example of FIG. 16, the AP transmits DATA PPDUs to STA1, STA2, STA3, and STA4 on four subchannels, respectively. While not shown for clarity of description, the plurality of DATA PPDUs may be transmitted in a HE PPDU frame format (e.g., one or more of a L-STF, a L-LTF, a L-SIG, and a HE-SIG-A are transmitted on one channel, one or more of a HE-STF, a HE-LTF, a HE-SIG-B, and a HE-SIG-C are transmitted respectively on each subchannel, and a PSDU is transmitted on each subchannel) in FIG. 16. That is, a DL DATA PPDU of FIG. 16 may be configured similarly to a UL DATA PPDU of FIG. 13 and a UL ACK PPDU of FIG. 16 may be configured similarly to a DL ACK PPDU of FIG. 13.

Upon receipt of a PSDU on a subchannel from the AP, each STA may transmit an ACK in response to the received PSDU, in the form of a block ACK on the subchannel in which the PSDU has been received.

Meanwhile, if the ACK policy of a DATA PPDU transmitted on a subchannel is normal ACK, an STA that has received the DATA PPDU responds to the DATA PPDU with a normal ACK PPDU, instead of a block ACK PPDU. For example, in the case where a DATA PPDU is transmitted in the form of an A-MPDU, like a VHT single PPDU or an HE single PPDU but includes only one MPDU, it may be regulated that an STA receiving the DATA PPDU responds to the DATA PPDU with a normal ACK PPDU, instead of a block ACK PPDU.

Considering the above, it may occur that DATA PPDUs transmitted on different subchannels have different ACK policies. In this case, each STA receiving a DATA PPDU transmits a different type of ACK PPDU. For example, STA1 may transmit a block ACK PPDU to the AP, as an ACK in response to a PSDU received on a first subchannel, and STA2 may transmit a normal ACK PPDU to the AP, as an ACK in response to a PSDU received on a second subchannel. Since a normal ACK PPDU and a block ACK PPDU typically have different lengths, the length of the response frame transmitted on the first subchannel by STA1 may be different from the length of the response frame transmitted on the second subchannel by STA2. However, to enable a receiver (e.g., the AP) to receive response frames successfully in MU-MIMO or OFDMA in which a plurality of STAs perform simultaneous transmissions, the STAs need to be identical in terms of the length, transmission time, or type of response frames that the STAs transmit. Therefore, for the plurality of STAs, the same ACK policy should be configured for DATA PPDUs transmitted on the plurality of subchannels.

In the example of FIG. 16, data frames that the AP transmits to the plurality of STAs in a DL MU transmission may be regarded as trigger frames for ACK frames that the plurality of STAs transmit to the AP in a UL MU transmission. That is, the UL MU ACK frames may be transmitted based on information of the trigger frames for them (e.g., the ACK policies of the DL MU data frames).

As described above, a plurality of block ACK frames transmitted simultaneously on a plurality of subchannels by a plurality of STAs may have the same property (e.g., the same length, transmission time, or type).

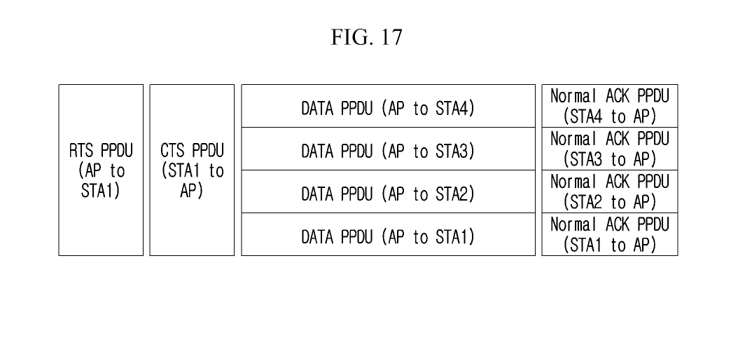

FIG. 17 depicts another exemplary ACK procedure performed in response to a DL MU transmission according to the present invention.

FIG. 17 illustrates an example in which ACK frames transmitted in response to a DL MU transmission triggered by a trigger frame (i.e., a CTS frame) transmitted by an STA have the same property for a plurality of STAs. In FIG. 17, if the ACK policy of a DATA PPDU is normal ACK, like a VHT single PPDU or a HE single PPDU, the ACK policy of a DATA PPDU transmitted on each subchannel is set uniformly to normal ACK and response frames for the DATA PPDUs are received as normal ACK PPDUs.

In the example of FIG. 17, data frames that the AP transmits to the plurality of STAs in a DL MU transmission may be regarded as trigger frames for ACK frames that the plurality of STAs transmit to the AP in a UL MU transmission. That is, the UL MU ACK frames may be transmitted based on information of the trigger frames for them (e.g., the ACK policies of the DL MU data frames).

As described above, a plurality of normal ACK frames transmitted simultaneously on a plurality of subchannels by a plurality of STAs may have the same property (e.g., the same length, transmission time, or type).

As in the example of FIG. 16 or FIG. 17, the same ACK policy should be set for ACKs transmitted by all STAs paired for MU-MIMO or OFDMA. For example, the ACK policy should be set so as to avoid the case where the ACK policy of a DATA PPDU transmitted on a subchannel is block ACK and the ACK policy of a DATA PPDU transmitted on another subchannel is normal ACK, and DATA PPDUs should be transmitted, which enable the same type of ACK policy across all subchannels (or for all STAs).

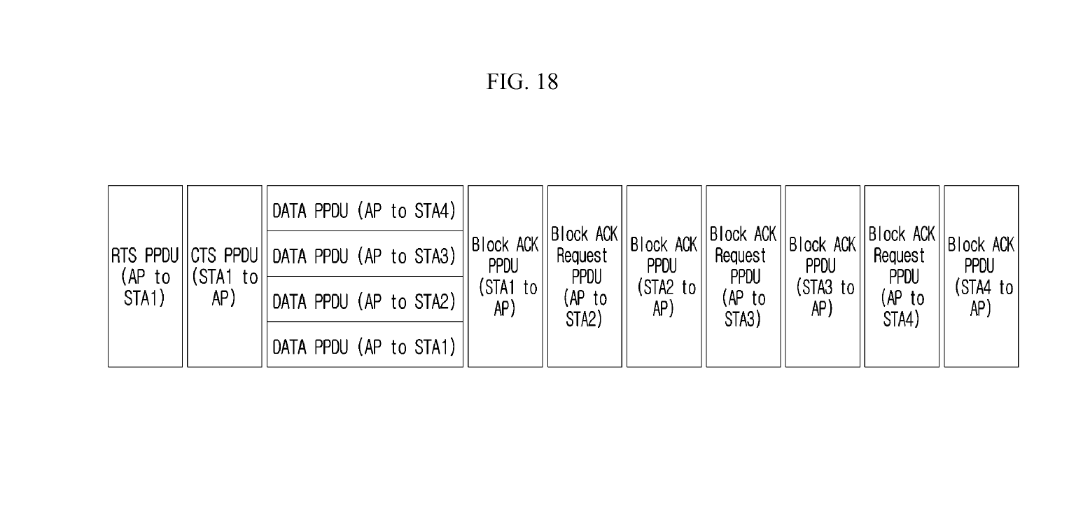

FIG. 18 depicts another exemplary ACK procedure performed in response to a DL MU transmission according to the present invention.

In FIG. 8, ACK frames transmitted in response to a DL MU transmission triggered by a trigger frame (i.e., a CTS frame) transmitted by an STA have the same property for a plurality of STAs.

FIG. 18 illustrates an exemplary ACK procedure in the case where DATA PPDUs having different ACK policies are transmitted in DL MU-MIMO or OFDMA. In the example of FIG. 18, the AP and STA1 exchange an RTS PPDU and a CTS PPDU with each other and the AP transmits DATA PPDUs in MU-MIMO or OFDMA to a plurality of STAs, as in the example of FIG. 16. Thus, a redundant description is avoided herein.

Among DATA PPDUs transmitted on a plurality of subchannels, the ACK policy of a DATA PPDU transmitted on a subchannel may be set to Implicit Block Ack Request, while the ACK policies of DATA PPDUs transmitted on the remaining subchannels may be set to block ACK. Therefore, the plurality of STAs, which have received data in DL MU-MIMO or OFDMA mode, may transmit ACKs to the AP sequentially in time.

For example, if the ACK policy of a DATA PPDU transmitted to STA1 on the first subchannel is Implicit Block Ack Request, STA1 may transmit a block ACK PPDU to the AP even though STA1 does not receive a block ACK request from the AP after receiving the DATA PPDU. Herein, STA1 may transmit the block ACK PPDU not on a subchannel but all subchannels including the subchannel (e.g., on one channel).

After receiving a block ACK request PPDU from the AP, the remaining STAs (i.e., STA2, STA3, and STA4) may transmit block ACK PPDUs to the AP accordingly. The block ACK request PPDU and the block ACK PPDUs may be transmitted not on subchannels in which related DATA PPDUs have been received but on all the subchannels including the subchannels (e.g., on the one channel).

The plurality of block ACK frames that the plurality of STAs transmit sequentially in time on one channel as described above may have the same property (e.g., the same length, transmission time, or type).

In the foregoing example of the present invention, an AP may transmit a DL MU frame to a plurality of STAs and receive UL ACK frames from the plurality of STAs in response to the DL MU frame. Since the transmission mode of the UL ACK frames is determined based on information provided by the DL MU frame, the AP may receive the UL ACK frames according to the transmission mode. In other words, if the AP transmits a DL MU data frame having the same ACK policy for all of the STAs, the AP may receive a UL MU ACK frame (e.g., the example of FIG. 16 or FIG. 17). If the AP transmits a DL MU data frame having different ACK policies for the plurality of STAs, the AP may receive UL SU ACK frames sequentially (e.g., the example of FIG. 18).

If an STA receives a DL MU data frame having DL data for the STA and DL data for one or more other STAs from the AP, the STA may determine the transmission mode of a UL ACK frame based on the DL MU data frame. That is, upon receipt of a DL MU data frame having the same ACK policy for all STAs, the STA may transmit its individual ACK frame simultaneously with individual ACK frames of one or more other STAs (e.g., the example of FIG. 16 or FIG. 17). On the other hand, upon receipt of a DL MU data frame having different ACK policies for the plurality of STAs, the STA may transmit a UL SU ACK frame at a transmission timing indicated by the AP (e.g., the example of FIG. 18).

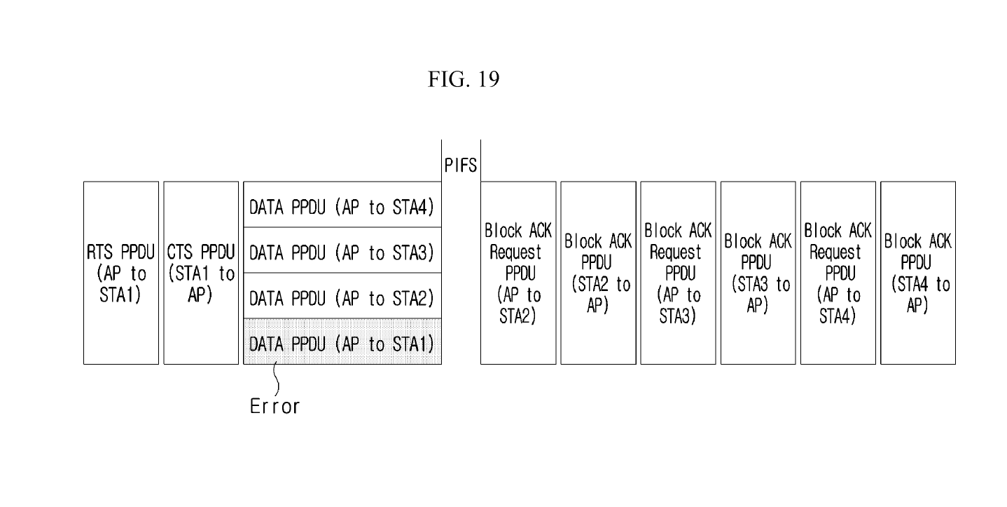

FIG. 19 depicts an error recovery procedure for a DL MU transmission according to the present invention.

The example of FIG. 19 illustrates that in a block ACK scheme in which an STA transmits a block ACK PPDU to an AP across all subchannels (i.e., one channel as illustrated in FIG. 18), some (e.g., STA1) of all STAs fails to receive a DATA PPDU on a subchannel allocated to the STA from the AP (i.e., a reception error occurs).

In the example of FIG. 19, the AP and STA1 exchange an RTS PPDU and a CTS PPDU with each other and the AP transmits DATA PPDUs to a plurality of STAs, as in the example of FIG. 16. Thus, a redundant description is avoided herein.

It is assumed in FIG. 19 that the ACK policy of a DATA PPDU transmitted on the first subchannel may be set to Implicit Block Ack Request, while the ACK policies of DATA PPDUs transmitted on the remaining subchannels may be set to block ACK (i.e., the same assumption as for the exemplary ACK policy setting of DATA PPDUs in FIG. 18).

It is assumed that although the AP transmits DATA PPDUs to all STAs on subchannels allocated to the STAs, STA2, STA3, and STA4 receive DATA PPDUs from the AP on the second, third, and fourth subchannels, while STA1 fails to receive a DATA PPDU from the AP on the first subchannel. That is, it is assumed that STA1 fails to receive a valid PPDU (STA1 does not receive a PPDU itself), rather than although STA1 receives a valid PPDU from the AP (e.g., STA1 succeeds in a CRC check of the received PPDU), STA1 fails to receive an MPDU(s) included in the valid PPDU.

In this case, after transmitting DATA PPDUs to the plurality of STAs on the plurality of subchannels, the AP awaits reception of a block ACK PPDU from STA1 allocated to the first channel for which the ACK policy is set to Implicit Block Ack Request. However, if STA1 fails to receive a DATA PPDU as described above, STA1 may not transmit a block ACK PPDU. If the AP fails to sense any signal during a block ACK PPDU response timeout period, the AP may perform the PIFS recovery procedure. Upon occurrence of a response timeout, the AP being a TXOP owner monitors a wireless medium during the PIFS. If the channel is idle, the AP may transmit a block ACK request PPDU to STA2 and receive a block ACK PPDU from STA2. After receiving the block ACK request PPDU from the AP, other STAs (i.e., STA3 and STA4) may transmit block ACK PPDUs to the AP accordingly.

According to the present invention, a plurality of STAs may provide requested receiving BandWidth (BW) information for an MU transmission to an MU transmitter by a trigger frame triggering the MU transmission (e.g., a CTS frame, a PS-Poll frame, an ACK frame, etc.).

To increase the efficiency of an MU-MIMO or OFDMA transmission, it is necessary to determine a suitable subchannel (i.e., the frequency position of a subchannel) for each user (or STA) at the time of the MU-MIMO or OFDMA transmission. In a DL MU-MIMO or OFDMA transmission as well as a UL MU-MIMO or OFDMA transmission, a DATA PPDU should be transmitted and received on a subchannel suitable for each STA (e.g., a subchannel expected to have the highest MCS order, the highest data rate, or the lowest error rate) in consideration of Channel State Information (CSI) between the AP and the STA.

In the PSM, an STA may enter (or switch to) an awake state at a predetermined time point during a doze-state operation. For example, the PSM STA may wake up at every predetermined time interval to determine whether the AP has data to be transmitted to the STA. For example, the doze-state STA may wake up at every predetermined time interval (e.g., a listen interval) in order to receive a beacon frame from the AP. The beacon frame includes a Traffic Indication Map (TIM) Information Element (IE). The TIM IE includes information indicating to each STA that the AP has buffered traffic for its associated STAs.

From the perspective of the AP, the AP does not know when the STA operating in the PSM enters the awake state until receiving a specific frame from the STA. For example, the STA operating in the PSM may transmit a PS-Poll frame requesting transmission of a frame to the STA or a trigger frame to the AP. Unless otherwise specified, the AP may transmit this PS-Poll or trigger frame to the STA at an arbitrary time point after the STA enters the awake state. Therefore, how and when to perform a sounding procedure to determine a channel state between the STA and the AP and how to determine a subchannel based on the determined channel state become issues. According to the present invention, a method for determining channel states between an AP and a plurality of STAs by the STAs and a method for determining subchannels for an MU-MIMO or OFDMA transmission by the plurality of STAs may be applied.

FIG. 20 depicts an exemplary determination of subchannels for an MU-MIMO or OFDMA transmission according to the present invention.

According to the present invention, to enable a plurality of STAs to acquire CSI between an AP and the STAs, the STAs may transmit sounding Null Data Packet (NDP) frames to the AP a predetermined time (e.g., an SIFS) after the AP transmits a beacon frame.

If the OFDMA mode is implemented based on 256 FFT resulting from four times downclocking of 64 FFT in a 20-MHz channel BW, the symbols of a sounding NDP frame may be configured using 256 FFT in the 20-MHz channel BW. That is, considering that the OFDMA transmission mode is based on 256 FFT, a sounding NDP frame and an OFDMA transmission may be configured in the same FFT. Therefore, the sounding NDP frame may effectively support OFDMA (i.e., a receiver of the sounding NDP frame may determine CSS of a subchannel accurately).

Meanwhile, for co-existence with legacy STAs, a part of the sounding NDP frame (e.g., a preamble part of the sounding NDP frame) may be configured to include 64 FFT-based symbols in the 20-MHz channel BW, like a beacon frame. The term ‘64 FFT-based symbol’ is used mainly with respect to the 20-MHz channel BW. If the term ‘64 FFT-based symbol’ is used irrespective of the channel bandwidth, this may mean that a frame includes a 3.2 μs symbol duration and symbols with a subcarrier spacing of 312.5 kHz. The term ‘256 FFT-based symbol’ is used mainly with respect to the 20-MHz channel bandwidth. If the term ‘256 FFT-based symbol’ is used irrespective of the channel bandwidth, this may mean that a frame includes a 12.8 μs symbol duration and symbols with a subcarrier spacing of 78.125 kHz.

In the example of FIG. 20, the AP transmits DATA PPDUs to STA1, STA2, STA3, and STA4 that operate in the PSM on the subchannels allocated to the STAs in MU-MIMO or OFDMA. The upper drawing of FIG. 20 focuses on an operation of STA1, whereas the lower drawing of FIG. 20 focuses on an operation of STA4. For clarity of description, a drawing illustrating operations of STA2 and STA3 is omitted. While the operations of STA1 to STA4 are shown as separately performed, it is to be understood that the operations of STA1 to STA4 are performed in parallel in the same frequency area.

In the PSM, STA1, STA2, STA3, and STA4 may wake up according to a listen interval, listen to a beacon frame from the AP, check a TIM in the beacon frame, and determine that the AP has buffered data for the STAs. Subsequently, each STA may receive a sounding NDP frame after the beacon frame, estimate a DL channel state, and determine a preferred subchannel most suitable for the STA.

In the example of FIG. 20, it is assumed that STA1, STA2, STA3, and STA4 determine subchannel1, subchannel2, subchannel3, and subchannel4 are most optimum for them, respectively. Each STA may indicate to the AP that the STA is ready to receive buffered data from the AP by transmitting a PS-Poll or trigger frame. Each of STA1, STA2, STA3, and STA4 may transmit the PS-Poll or trigger frame according to a channel access backoff mechanism of CSMA/CA. In FIG. 20, STA1, STA2, STA3, and STA4 sequentially acquire their channel access right and transmit PS-Poll frames.

When an STA transmits a PS-Poll frame, the STA may include information indicating a DL subchannel most optimum for the STA (e.g., a Requested Receiving Bandwidth (BW) field) in the PS-Poll frame. Upon receipt of the PS-Poll frame, the AP may include information indicating a DL subchannel granted to the STA (e.g., a Granted Receiving BW field) in an ACK PPDU frame in response to the PS-Poll frame. The AP does not determine the granted receiving BW simply based on the information indicating the most optimum subchannel, received from the STA. Rather, the AP may determine a subchannel for each STA, taking into account a preferred subchannel of each STA, so that the AP may perform an OFDMA transmission to the plurality of STAs in the most optimum manner. For example, if STA2 and STA3 indicate that they prefer the same subchannel, subchannel2, the AP may mediate between STA2 and STA3, allocate a suitable subchannel to each STA, and indicate the allocated subchannels to STA2 and STA3, respectively.

While information about a subchannel allocated to each STA by the AP is shown in FIG. 20 as included in an ACK frame, it may be further contemplated as another example that an ACK frame is used just as an ACK for a PS-Poll frame, without including granted receiving BW information, and after receiving requested receiving BW information from all STAs (all STAs participating in an MU-MIMO or OFDMA transmission), the AP transmits granted receiving BW information for each STA before transmitting DATA PPDU frames in MU-MIMO or OFDMA. For this purpose, a management frame other than an ACK PPDU may be defined and used. Or an ACK frame may be used just as an ACK for a PS-Poll frame, without including granted receiving BW information, and granted receiving BW information for each STA may be included in a preamble part of a DATA PPDU frame transmitted in MU-MIMO or OFDMA.

In the upper drawing of FIG. 20, STA1 may include information indicating subchannel1 in the Requested Receiving BW field of a PS-Poll frame and transmit the PS-Poll frame to the AP. The AP may include information indicating subchannel1 in the Granted Receiving BW field of an ACK PPDU frame and transmit the ACK PPDU frame to STA1 in response to the PS-Poll frame. STA1 determines that a receiving BW granted to STA1 is subchannel1 and narrows its receiving BW to subchannel 1, thereby greatly reducing power consumption. That is, although STA1 attempts to detect (or overhear) a PPDU in a wide receiving BW (e.g., a 20-MHz channel at a specific frequency position), for beacon frame reception, sounding NDP frame reception, a backoff procedure for PS-Poll frame transmission, and ACK frame reception, STA1 attempts to detect a PPDU in a narrowed receiving BW (e.g., a 5-MHz subchannel at a specific frequency position) after checking information about its granted receiving BW in the example of FIG. 20. Consequently, the power consumption of the STA is reduced as much.

In the lower drawing of FIG. 20, STA4 may include information indicating subchannel4 in the Requested Receiving BW field of a PS-Poll frame and transmit the PS-Poll frame to the AP. The AP may include information indicating subchannel4 in the Granted Receiving BW field of an ACK PPDU frame and transmit the ACK PPDU frame to STA4 in response to the PS-Poll frame. STA4 determines that a receiving BW granted to STA1 is subchannel4 and narrows its receiving BW to subchannel4, thereby greatly reducing power consumption. That is, although STA4 attempts to detect (or overhear) a PPDU in a wide receiving BW (e.g., a 20-MHz channel at a specific frequency position), for beacon frame reception, sounding NDP frame reception, a backoff procedure for PS-Poll frame transmission, and ACK frame reception, STA1 attempts to detect a PPDU in a narrowed receiving BW (e.g., a 5-MHz subchannel at a specific frequency position) after checking information about its granted receiving BW in the example of FIG. 20. Consequently, the power consumption of the STA is reduced as much.

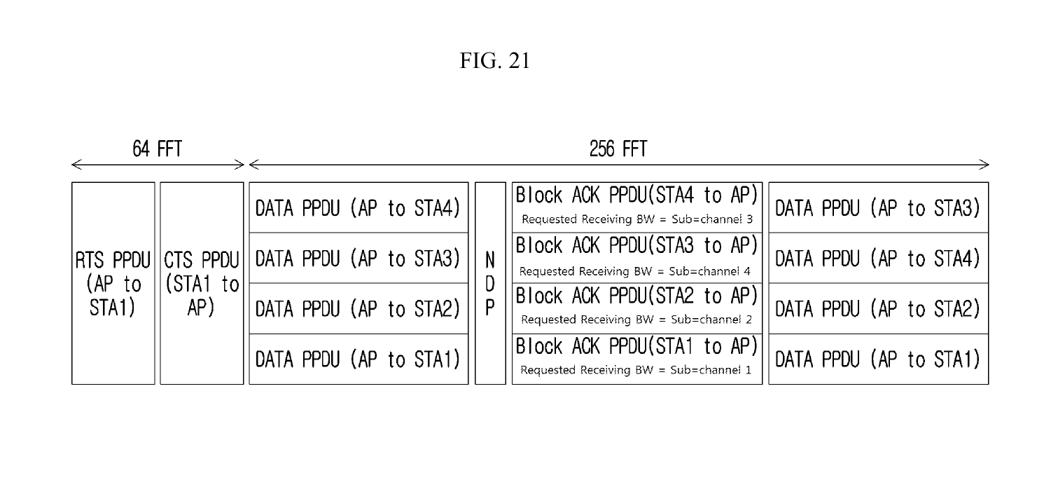

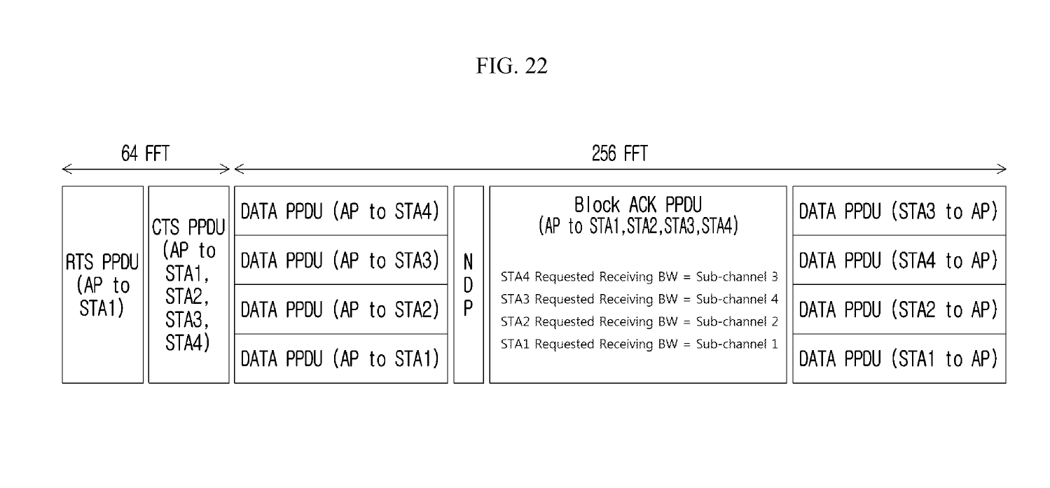

FIGS. 21 and 22 depict other examples of determining subchannels for an MU transmission according to the present invention.

According to the present invention, a method for changing a subchannel allocation for an STA in the middle of a TXOP during an MU-MIMO or OFDMA transmission may be applied. For example, information about the most suitable subchannel for each STA may be included in the form of the Requested Receiving BW field in an ACK PPDU or a block ACK PPDU transmitted during a TXOP.

A kind of control frame, ACK PPDU or block ACK PPDU may include a High Throughput (HT) Control field for link adaptation in a MAC header. For a HE PPDU, a HE variant HT Control field may be included in a MAC header. A data receiver (e.g., a destination) may use the HE variant HT Control field to indicate transmission parameters (e.g., an MCS, the number of spatial streams, etc.) most optimum for the receiver to a transmitter. Information about a requested receiving BW (e.g., a Requested Receiving BW field) according to the present invention may be included in the HE variant HE Control field.

In the example of FIG. 21, the AP and STA1 exchange an RTS PPDU and a CTS PPDU with each other and the AP transmits DATA PPDUs in MU-MIMO or OFDMA to a plurality of STAs, as in the example of FIG. 16. Thus, a redundant description is avoided herein. The RTS PPDU and the CTS PPDU may include 64 FFT-based symbols, and an MU-MIMO or OFDMA DATA PPDU may include 256 FFT-based symbols (however, the preamble part of the DATA PPDU may include 64 FFT-based symbols).

A transmitter (i.e., the AP) may set an MCA feedback Request (MRQ) bit to 1 in the HE variant HT Control field of the MAC header of a DATA PPDU for each STA and transmit the DATA PPDU to the STA. Upon receipt of the DATA PPDU including this HE variant HT Control field, each STA may determine that the AP requests an MCS feedback from the STA or wants to know a DL subchannel most optimum for each STA, in a link adaptation process.

Also, the AP may transmit a sounding NDP frame across the entire subchannels with a predetermined spacing from the DATA PPDU (e.g., after the SIFS). Each STA may determine link adaptation-related feedback information and DL subchannel information more accurately based on the sounding NDP frame.

Subsequently, the STA may transmit an ACK to the AP in response to the DATA PPDU. The STA may include information about a DL subchannel most optimum for the STA in an ACK frame transmitted to the AP in response to a previous DL transmission. For example, STA1, STA2, STA3, and STA4 may include information indicating subchannel1, subchannel2, subchannel3, and subchannel4 as requested receiving BWs in their ACK frames, respectively. While block ACK PPDUs transmitted simultaneously on the respective subchannels are shown as ACK frames in the example of FIG. 21, normal ACK PPDUs transmitted simultaneously on the respective subchannels as illustrated in FIG. 17 or block ACK PPDUs transmitted sequentially in one channel BW as illustrated in FIG. 18 may be used as an ACK scheme.

Upon acquisition of information about a subchannel most optimum for each STA in an ACK frame from the STA, the AP may schedule a DL subchannel to be allocated to each STA (i.e., perform DL subchannel rescheduling) for the next DATA PPDU transmission, taking into account the acquired information (however, not limited to the preferred subchannel information of the STA). In the example of FIG. 21, the AP transmits DATA PPDUs to STA1 on subchannel1, to STA2 on subchannel2, to STA 3 on subchannel3, and to STA4 on subchannel4 by approving the preferred subchannels of the STAs. Information about the subchannel allocated to each STA may be included in the preamble of a DATA PPDU, or in a predetermined management frame transmitted between a block ACK PPDU and the DATA PPDU, while not shown in FIG. 21.

In the example of FIG. 22, RTS PPDU transmission, CTS PPDU transmission, and MU-MIMO or OFDMA transmission of a DATA PPDU on a subchannel from each STA are performed in the same manner as in the example of FIG. 13 and thus a redundant description is avoided herein. The RTS PPDU and the CTS PPDU may include 64 FFT-based symbols, and the MU-MIMO or OFDMA DATA PPDU may include 256 FFT-based symbols (however, the preamble part of the DATA PPDU may include 64 FFT-based symbols).

A transmitter (i.e., each STA) may set an MRQ bit to 1 in the HE variant HT Control field of the MAC header of a DATA PPDU for the AP and transmit the DATA PPDU to the AP. Upon receipt of the DATA PPDU including this HE variant HT Control field, the AP may determine that the STA requests an MCS feedback from the AP or wants to know a UL subchannel most optimum for the STA, in a link adaptation process.

Also, the STA may transmit a sounding NDP frame to the AP across the entire subchannels with a predetermined spacing from the DATA PPDU (e.g., after the SIFS) in MU-MIMO or OFDMA. The AP may determine link adaptation-related feedback information and DL subchannel information more accurately based on the sounding NDP frame.

Subsequently, the AP may transmit an ACK to the STA in response to the DATA PPDU. The AP may include information about a UL subchannel most optimum for the STA in an ACK frame transmitted by the AP. For example, the AP may include information indicating subchannel 1 for STA1, subchannel2 for STA2, subchannel3 for STA3, and subchannel4 for STA4 as requested receiving BWs in the ACK frame. While a block ACK PPDU is transmitted in one channel BW as an ACK frame in the example of FIG. 22, block ACK PPDUs transmitted simultaneously on the respective subchannels as illustrated in FIG. 13 may be used as an ACK scheme.

Upon acquisition of requested transmitting BW information (i.e., UL subchannel rescheduling information) in the ACK frame from the AP, each STA may determine a UL subchannel allocated to the STA for the next DATA PPDU transmission. In the example of FIG. 22, STA1, STA2 STA3 and STA4 transmit DATA PPDUs to the AP on subchannel1, subchannel2, subchannel3, and subchannel4, respectively. In this manner, an ACK frame transmitted in response to an MU-MIMO or OFDMAUL DATA PPDU may be used as a trigger frame (or PS-Polling frame) for a subsequent DATA PPDU transmission, as well as it includes ACK information according to its original usage.

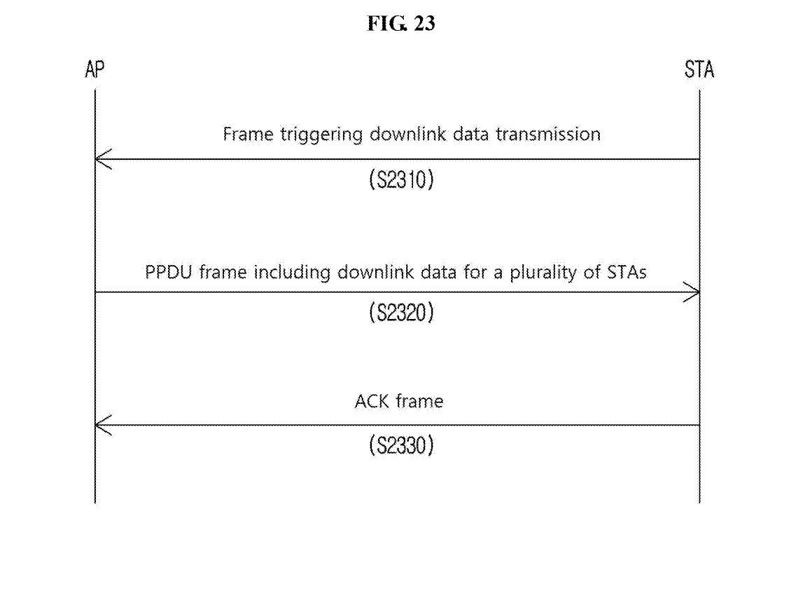

FIG. 23 is a flowchart illustrating an exemplary method according to the present invention.

In step S2310, an STA may transmit a frame triggering a DL data transmission to an AP. Also, one or more other STAs may transmit trigger frames triggering a DL data transmission to the AP. For example, the trigger frame may be a CTS frame responding to an RTS frame transmitted by the AP or a PS-Poll frame indicating that an STA is ready for receiving DL data, as the STA is aware of the presence of buffered data for the STA from a TIM included in a beacon frame received from the AP.

In step S2320, the AP may transmit a PPDU frame including DL data for a plurality of STAs including the STA. The DL data for the plurality of STAs may be transmitted to different STAs on a plurality of subchannels (i.e., in DL MU-MIMO or OFDMA).

In step S2330, the STA may transmit an ACK frame in response to the received DL data. The ACK frame transmitted by the STA and an ACK frame transmitted by each of one or more other STAs among the plurality of STAs may have the same length (transmission time or type). For this purpose, the same ACK policy may be set for the DL data for each of the plurality of STAs in step S2320.

While the exemplary method has been described with reference to FIG. 23 as a series of operations for simplicity of description, this does not limit the sequence of steps. When needed, steps may be performed at the same time or in a different sequence. All of the exemplary steps are not always necessary to implement the method according to the present invention.

The foregoing embodiments of the present invention may be implemented independently or one or more of the embodiments may be implemented simultaneously, for the method of FIG. 23.

The present invention includes an apparatus for processing or performing the method according to the present invention (e.g., the wireless device and its components described with reference to FIGS. 1, 2, and 3).

The present invention includes software (an operating system (OS), an application, firmware, a program, etc.) for executing the method according to the present invention in a device or a computer, and a medium storing the software that can be executed in a device or a computer.

While various embodiments of the present invention have been described in the context of an IEEE 802.11 system, they are applicable to various mobile communication systems.

What is claimed is:

1. A method for transmitting an ACKnowledgement (ACK) in response to downlink data received from an Access Point (AP) by a Station (STA) in a Wireless Local Area Network (WLAN), the method comprising:
receiving, from the AP, a downlink frame including downlink data for the STA and downlink data for one or more other STAs; and
transmitting an ACK frame to the AP in response to the downlink data for the STA, simultaneously with transmission of ACK frames from the one or more other STAs,
wherein the ACK frames transmitted by the STA and the one or more other STAs have the same length.

2. The method according to claim 1, wherein the downlink data for the plurality of STAs have the same ACK policy.

3. The method according to claim 1, wherein when the AP receives the ACK frames from the plurality of STAs and the ACK frames do not include ACK information about the downlink data transmitted to one of the plurality of STAs, the AP determines that transmission of the downlink data to the one STA has been failed and operates, considering that a response timeout has occurred.

4. The method according to claim 1, wherein the ACK frames are block ACK frames, and a block ACK frame from the STA and block ACK frames from the one or more other STAs are transmitted simultaneously on different subchannels.

5. The method according to claim 1, wherein the ACK frames are normal ACK frames, and a normal ACK frame from the STA and normal ACK frames from the one or more other STAs are transmitted simultaneously on different subchannels.

6. The method according to claim 1, wherein the STA transmits a frame triggering the downlink data frame to the AP and the frame triggering the downlink data frame includes information about a requested receiving bandwidth of the STA.

7. The method according to claim 6, wherein after the STA transmits the frame triggering the downlink data frame, the AP transmits to the STA information about a granted receiving bandwidth for the STA, determined by the AP before the STA receives the downlink data.

8. The method according to claim 6, wherein before the STA transmits the frame triggering the downlink data frame, the STA receives a sounding Null Data Packet (NDP) frame from the AP.

9. The method according to claim 6, wherein the frame triggering the downlink data frame is one of a Clear To Send (CTS) frame transmitted in response to a Request To Send (RTS) frame from the AP, a Power Save-Poll (PS-Poll) frame requesting transmission of downlink data to the STA based on a Traffic Indication Map (TIM) of a beacon frame from the AP, or an ACK frame transmitted in response to a previous downlink data transmission to the STA.

10. The method according to claim 1, wherein the ACK frame transmitted by the STA includes information about a requested receiving bandwidth of the STA.

11. A method for receiving an ACKnowledgement (ACK) in response to a downlink data transmission to a plurality of Stations (STAs) by an Access Point (AP) in a Wireless Local Area Network (WLAN), the method comprising:
receiving frames triggering the downlink data transmission from one or more of the plurality of STAs;
transmitting a downlink frame including downlink data for the plurality of STAs to the plurality of STAs; and
receiving an ACK frame from one of the plurality of STAs, simultaneously with ACK frames from one or more other STAs,
wherein the ACK frames transmitted by the plurality of STAs have the same length.

12. The method according to claim 11, wherein the downlink data for the plurality of STAs have the same ACK policy.

13. The method according to claim 11, wherein when the AP receives the ACK frames from the plurality of STAs and the ACK frames do not include ACK information about the downlink data transmitted to another one of the plurality of STAs, the AP determines that transmission of the downlink data to the another STA has been failed and operates, considering that a response timeout has occurred.

14. The method according to claim 11, wherein the ACK frames are block ACK frames, and a block ACK frame from the one STA and block ACK frames from the one or more other STAs are transmitted simultaneously on different subchannels.

15. The method according to claim 11, wherein the ACK frames are normal ACK frames, and a normal ACK frame from the one STA and normal ACK frames from the one or more other STAs are transmitted simultaneously on different subchannels.

16. The method according to claim 11, wherein the one STA transmits a frame triggering the downlink data transmission to the AP and the frame triggering the downlink data transmission includes information about a requested receiving bandwidth of the one STA.

17. The method according to claim 16, wherein after the one STA transmits the frame triggering the downlink data transmission, the AP transmits to the one STA information about a granted receiving bandwidth for the STA, determined by the AP before the one STA receives the downlink data.

18. The method according to claim 16, wherein before the one STA transmits the frame triggering the downlink data transmission, the AP transmits a sounding Null Data Packet (NDP) frame to the one STA.

19. The method according to claim 16, wherein the frame triggering the downlink data transmission is one of a Clear To Send (CTS) frame transmitted in response to a Request To Send (RTS) frame from the AP, a Power Save-Poll (PS-Poll) frame requesting transmission of downlink data to the one STA based on a Traffic Indication Map (TIM) of a beacon frame from the AP, and an ACK frame transmitted in response to a previous downlink data transmission to the one STA.

20. The method according to claim 11, wherein the ACK frame transmitted by the one STA includes information about a requested receiving bandwidth of the one STA.
